(19) United States
(12) Patent Application Publication
(10) Pub. No.: US 2023/0033012 A1
(43) Pub. Date: Feb. 2, 2023

(54) FOOT AND LOWER LEG CLEANING AND TREATMENT DEVICE

(71) Applicant: Romolo Lorenzo Bertani, Sydney (AU)

(72) Inventors: Romolo Lorenzo Bertani, Bella Vista, New South Wales (AU); Amir Moezzi, Kogarah, New South Wales (AU); Alessandro Bertani, Bella Vista, New South Wales (AU); Mithun Powar, Alexandria, New South Wales (AU); Yuanxuan Zhang, South Perth, Western Australia (AU)

(21) Appl. No.: 17/788,465

(22) PCT Filed: Dec. 23, 2020
(86) PCT No.: PCT/AU2020/051422

§ 371 Date: Jun. 23, 2022

(30) Foreign Application Priority Data
Dec. 23, 2019 (AU) 2019904907

(51) Int. Cl. A47K 3/022; A61H 35/00

(52) U.S. Cl. CPC A47K 3/022; A61H 35/006; A61H 2201/0192; A61H 9/005

(57) ABSTRACT

A device for washing or treating the feet and lower legs of a user comprises an outer housing; a base assembly located in the outer housing; access means for providing access to a base assembly, a controller for controlling operation of the device, and a fluid supply mechanism. The base assembly includes a pair of footrests for supporting the feet and lower legs of a user during washing or treating, at least one rotatable transversely extending cleaning or treating assembly located above the footrest for washing or treating a user's feet; and a plurality of rotatable upright cleaning or treating assemblies for washing or treating the lower legs of the user. A ilting assembly is provided for tilting the base assembly relative to the outer housing through a plurality of inclined positions.

### FIELD OF THE INVENTION

This disclosure relates to a foot and lower leg cleaning and treatment device for washing and treating the feet and lower legs of a user.

### BACKGROUND OF THE INVENTION

Many people suffer from poor circulation to their lower legs and feet, which may result in swelling, discomfort and a higher risk of blood clots. For example, the elderly, pregnant women and those with limited mobility, disabilities, or medical conditions have a higher risk of poor circulation to their lower legs and feet.

In some instances, lower leg massages and soaking of the feet may be used to alleviate discomfort and swelling. However, lower leg massages and soaking of the feet may not alone assist in promoting circulation to a person's lower legs and feet and some people may experience difficulties in accessing a tub to soak their feet. For example, the elderly, and those with limited mobility or disabilities may have difficultly lifting their legs and feet into a tub for soaking, especially if they are in a seated position. Massages also require the intervention regular intervention of a massage therapist which few can afford to have unlimited access to.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

According to an embodiment of the disclosure, there is provided a device for washing or treating the feet and lower legs of a user, comprising: an outer housing;

a base assembly located in the outer housing; access means for providing access of the feet and lower legs to the base assembly;

a controller for controlling operation of the device; and

a fluid supply mechanism;

the base assembly including:
at least one footrest for supporting the feet and lower legs of a user during washing or treating;
one or more rotatable transversely extending cleaning or treating assemblies located above the footrest for washing or treating a user's feet; and
one or more rotatable upright cleaning or treating assemblies for washing or treating one or both lower legs of the user; and

a tilting assembly for tilting the base assembly relative to the outer housing through a plurality of inclined positions.

The base assembly may include a hull housing one or more drive assemblies in a waterproof plenum for driving the one or more rotatable transversely extending cleaning or treating assemblies and the one or more rotatable upright cleaning or treating assemblies.

The tilting assembly may include a curved guide and follower arrangement acting between the base assembly and the outer housing for allowing the base assembly to travel along a curved path relative to the outer housing.

The base assembly may include an inner housing and the tilting assembly includes one or more lifting and lowering mechanisms connecting the base assembly to the inner surface of the outer housing for tilting the inner housing with respect to the outer housing.

The one or more rotatable upright cleaning or treating assemblies may be carried on a guiding mechanism for moving each of the one or more cleaning or treating assemblies around an outer portion of the footrest during a lower leg and foot cleaning or treating cycle in which outwardly facing portions of the lower legs are cleaned or treated

Each guiding mechanism may be dynamically adjustable for accommodating different lower leg profiles.

Each guiding mechanism may include a rotary arm the length of the rotary arm being dynamically adjustable and including biasing means for biasing the one or more upright cleaning or treating assemblies against the one or more lower legs of a user thereby to accommodate the different lower leg profiles.

The one or more rotatable upright cleaning or treating assemblies may include a fixed intermediate rotatable cleaning or treating assembly which is positioned between the footrests and is configured to clean or treat the inwardly facing or medial portions of the lower legs of a user.

The one or more rotatable upright cleaning or treating assemblies may include a pair of cleaning or treating assemblies carried on a corresponding pair of guiding mechanisms for moving each of the cleaning or treating assemblies around both an outer portion of the footrest and an inner portion of the footrest during a lower leg and foot cleaning or treating cycle in which outwardly and inwardly facing or medial portions of the lower legs are cleaned or treated, each guiding mechanism being dynamically adjustable for accommodating different lower leg profiles.

The inwardly facing or medial portions of each of the lower legs are simultaneously or alternately cleaned or treated by the guiding mechanisms.

The access means may include an access door assembly having a plurality of telescoping panels movable between open and closed positions.

The outer housing may include a control display interfacing with the controller for displaying one or more indicators and/or controls of: water temperature, water intensity, water pressure, air drying intensity, inclination of the foot washer, or operation of the access means.

The rotatable transversely extending or rotatable upright cleaning or treating assemblies may include one or more of an interchangeable: coil attachment; brush attachment; sponge attachment; liquid jet attachment; air dryer attachment and massage attachment.

The coil attachment may include a cylindrical housing having a series of hollow concentric tubes separated by grooves having one or more balls provided on an interior surface therein. The coil attachment may be inflatable by an air supply mechanism. The coil attachment may be connected to an inclination mechanism for inclining the coil attachment relative to the base assembly.

The at least one footrest may include an array of micro actuators for detecting the size and/or dimensions of a user's feet on the footrest and providing varying pressure intensities to a user's feet.

The at least one footrest may include one or more supporting plates coupled to one or more biasing means for adjusting each footrest to accommodate the length and/or width of a user's foot.

The device may be integrated with a chair assembly, the chair assembly including a chair pivotally and slidably connected to a base for permitting the chair to pivot between a stowed configuration and a rotated configuration and to slide to and fro relative to the device.

According to another embodiment of the disclosure, there is provided a device for washing and/or treating the feet and lower legs of a user, comprising:

an outer housing partially surrounding an inner housing, wherein the inner housing defines a tub and is movable with respect to the outer housing between a plurality of inclined positions and a stowed position;

control means for controlling operation of the device; and

the tub including:
at least one footrest for supporting the feet of a user during washing or treating in an inclined position;
access means for providing the feet and lower legs of the user with access to the footrest;
a fluid supply mechanism for introducing fluid into the tub;
one or more rotatable transversely extending cleaning or treating assemblies located above the footrest for washing or treating a user's feet; and
one or more rotatable upright cleaning or treating assemblies for washing or treating one or both lower legs of the user.

Each of the one or more rotatable upright cleaning or treating assemblies that move around a portion of the footrest may be located on a rotary arm connected to the guiding mechanism for guiding the rotary arm around a track that surrounds an outer portion of the footrest, the length of the rotary arm being dynamically adjustable and including biasing means for biasing the one or more upright cleaning or treating assemblies against one or more lower legs of a user thereby to accommodate different lower leg profiles.

The one or more rotatable upright cleaning or treating assemblies may include a fixed intermediate rotatable cleaning or treating assembly which is positioned between the footrests and is configured to clean or treat the inwardly facing or medial portions of the lower legs of a user.

The access means may include an opening defined in a front portion of the tub and a moveable closure for selectively closing and accessing the front opening.

The movable closure may include a waterproofing structure for preventing the egress of water from the tub when the closure is in the closed position.

The movable closure may include one or more access doors that are slidably engaged with the inner housing between a raised and a lowered position for providing selective access to the at least one footrest, and actuating means for enabling selective raising and lowering of the one or more access doors.

The one or more access doors may include a plurality of panels connected to one or more sliding assemblies, each sliding assembly including one or more sliders that slidably engage one or more rails provided in a sidewall of the inner housing adjacent the opening, each slider being located on a threaded drive shaft driven by an actuator that moves each slider along the one or more rails for permitting stacking and unstacking of the panels.

The waterproofing structure may include a flexible waterproof shell that is configured to concertina between the lowered and raised positions.

The access means may include a pivoting arrangement between the outer housing and the tub, with the tub nesting within the outer housing and being configured relative to the outer housing to pivot between an access position in which the tub including a front wall of the tub pivots downwards to define an opening for inserting the feet and lower legs of the user and a raised position in which the front wall is raised and the feet are in place on the inclined footrests.

The access means may further include a pivotable front wall assembly in the tub including inner and outer shells pivotable between lowered open and raised closed positions.

A control display may interface with the control means for displaying one or more indicators and/or controls of: water temperature, water intensity, water pressure, air drying intensity, inclination of the inner housing with respect to the outer housing, or operation of the access doors.

The tub may be provided with a temperature variable fan assembly for drying and/or cooling a user's lower legs and feet.

The at least one footrest may include an array of micro actuators for detecting the size and/or dimensions of a user's feet on the footrest and an array of apertures for dispensing liquid and/or air to a user's feet.

Aspects of the invention extend to the individual interchangeable cleaning or treating assemblies.

According to a still further embodiment of the disclosure, there is provided a device for washing or treating the feet and lower legs of a user, comprising:

an outer housing;

a base assembly located in the outer housing;

access means for providing access of the feet and lower legs to the base assembly;

a controller for controlling operation of the device; and

a fluid supply mechanism;

the base assembly including:
at least one footrest for supporting the feet and lower legs of a user during washing or treating;
one or more rotatable transversely extending cleaning or treating assemblies located above the footrest for washing or treating a user's feet; and
one or more rotatable upright cleaning or treating assemblies for washing or treating one or both lower legs of the user,
wherein the one or more rotatable upright cleaning or treating assemblies are carried on a guiding mechanism for moving each of the one or more cleaning or treating assemblies around an outer portion of the footrest during a lower leg and foot cleaning or treating cycle in which outwardly facing portions of the lower legs are cleaned or treated, each guiding mechanism being dynamically adjustable for accommodating different lower leg profiles.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a perspective view of a first embodiment of a foot and lower leg treater or washer including an outer housing, an inner housing and a plurality of cleaning or treating assemblies;

FIG. 2 is an exploded perspective view of the foot and lower leg treater or washer shown in FIG. 1;

FIG. 3 is an enlarged view of Insert A shown in FIG. 2;

FIG. 4 is a perspective view of the foot and lower leg treater or washer shown in FIGS. 1-3 in an inclined position;

FIGS. 5a-5b are side views of a first embodiment of a lifting mechanism for inclining the foot and lower leg treater or washer of FIG. 3 in an inclined position and a stowed position, respectively;

FIG. 5c is a side view of a second embodiment of a lifting mechanism for inclining the foot and lower leg treater or washer shown in FIG. 3;

FIG. 6a is a perspective view of a base plate and access doors of the foot and lower leg treater or washer shown in FIGS. 1-2, 4 and 5b in an open position;

FIG. 6b is a rear perspective view of the base plate and access doors of the foot and lower leg treater or washer shown in FIG. 6a without the inner housing;

FIG. 6c is an enlarged view of Insert A shown in FIG. 6b;

FIG. 6d is a perspective view of the base plate and access doors shown in FIGS. 6a-6c in a closed position;

FIGS. 6e-6g are enlarged views of Inserts B-D shown in FIG. 6d;

FIG. 7a is a top view of a control panel of the foot and lower leg treater or washer shown in FIGS. 1-6f, which may also be applied to other embodiments of the leg treater or washer;

FIG. 7b is a block diagram of a controller connected to the control panel shown in FIG. 7a, which may also be applied to other embodiments of the leg treater or washer;

FIG. 8 is a top view of the foot and lower leg treater or washer shown in FIGS. 1-7;

FIG. 9 is a cutaway top view of the foot and lower leg treater or washer shown in FIGS. 1-8;

FIG. 10 is an exploded perspective view of a rotary arm of a rotatable upright cleaning or treating assembly shown in FIGS. 1-4 and 8;

FIG. 11 is a perspective view of the rotary arms fitted to a base plate of a base assembly;

FIG. 12 is a perspective detail of an adaptor for connecting the rotatable upright cleaning or treating assemblies shown in FIGS. 1-4 and 8 to the inner housing of the foot and lower leg treater or washer;

FIGS. 13a-13b are perspective views of a rotatable transverse cleaning and fan sub-assembly;

FIGS. 13c-13d are perspective views of a drive mechanism of the rotatable transverse cleaning or treating assembly shown in FIGS. 13a-13b;

FIGS. 14a-14d are respective perspective, side, front and perspective views of a base assembly including rotary coil attachments for the rotatable upright cleaning or treating assembly shown in FIGS. 1-4 and 8;

FIG. 15 is a perspective view of another embodiment of the foot and lower leg treater or washer;

FIGS. 16a-16b are respective front and cross-sectional views of a rotary brush attachment for the rotatable cleaning or treating assemblies shown in FIGS. 1-4 and 8;

FIGS. 17a-17c are respective top, cross-sectional and side views of a rotary sponge attachment for the rotatable cleaning or treating assemblies shown in FIGS. 1-4 and 8;

FIG. 18 is a perspective view of one embodiment of a foot rest of the foot and lower leg treater or washer shown in FIGS. 1-17c;

FIG. 19a is a perspective view of another embodiment of a foot and lower leg treater or washer in an open position;

FIGS. 19b-19c are respective perspective and side views of the foot and lower leg treater or washer shown in FIG. 19a in a closed position;

FIG. 20 is a perspective view of a base assembly including a fluid supply mechanism for supplying air and/or liquid to the cleaning or treating assemblies shown in

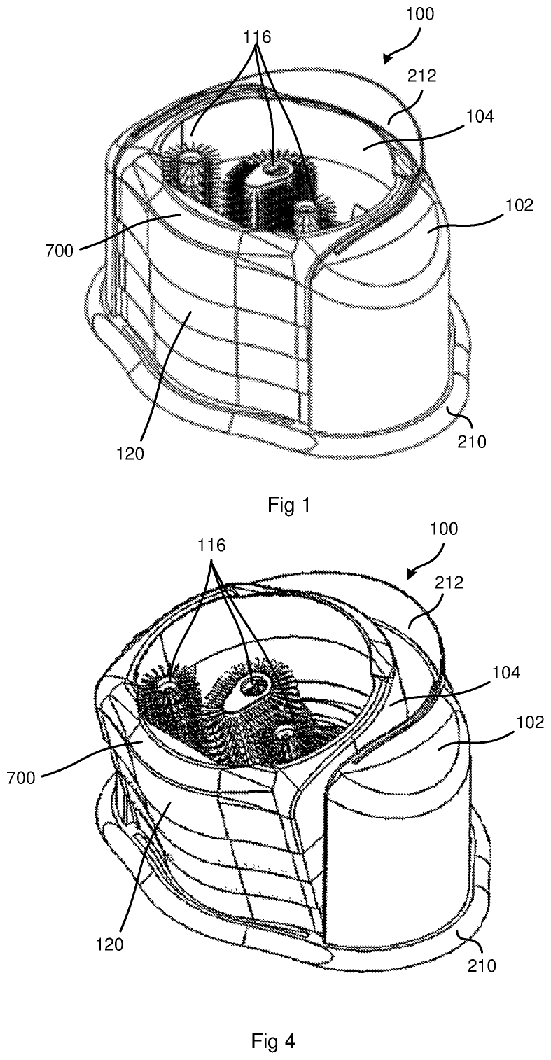

FIGS. 1-4, 8 and 13a-13b;

FIG. 21a is a perspective view of another embodiment of a foot and lower leg treater or washer in an open position; and

FIGS. 21b-21c are respective perspective and side views of the foot and lower leg treater or washer shown in FIG. 21a in a closed position;

FIG. 22a is a perspective view of another embodiment of a foot and lower leg treater or washer in a closed position;

FIG. 22b is a cutaway perspective view of the foot and lower leg treater or washer shown in FIG. 22a;

FIGS. 22c-22d enlarged views of Inserts E-F shown in FIG. 22b;

FIG. 23a is a perspective view of an embodiment of a base assembly including rotatable cleaning or treating assemblies and pipes for connecting to a cooling system;

FIGS. 23b-c are top views of the base assembly shown in FIG. 23a;

FIGS. 24a-24b are perspective views of another embodiment of a base assembly including rotatable cleaning or treating assemblies and pipes for connecting to a cooling system;

FIG. 24c-d are respective perspective and bottom views of an embodiment of a drive mechanism of the rotatable cleaning or treating assemblies shown in FIGS. 24a-b,

FIG. 25a-b are respective perspective and side views of a rotary arm of a rotatable upright cleaning or treating assembly including the drive mechanism shown in FIGS. 24a-d;

FIG. 25c is a cross-sectional view of the rotary arm shown in FIGS. 25a-b;

FIG. 26 is a perspective view of another embodiment of a drive mechanism of a rotary arm of the rotatable upright cleaning or treating assemblies of FIGS. 23a-c or FIGS. 24a-b;

FIGS. 27a-b are respective bottom and front views of yet another embodiment of a drive mechanism of the rotatable upright cleaning or treating assemblies of FIGS. 23a-c or FIGS. 24a-b;

FIGS. 28a-28b is a top view of another embodiment of a foot rest of the foot and lower leg treater or washer shown in FIGS. 23a-c, 24a-d, 25a-c, 26, and 27a-b;

FIGS. 29a-b are perspective views of another embodiment of a foot and lower leg treater or washer including a chair in a stowed configuration and a rotated configuration, respectively; and

FIG. 29c is a cross sectional view of the foot and lower leg treater or washer of FIG. 29a with the chair in a stowed configuration.

### DETAILED DESCRIPTION OF THE EMBODIMENTS

FIGS. 1-3 show a first embodiment of a foot and lower leg treater or washer 100 for washing or treating the feet and lower legs of a user. The foot and lower leg treater or washer 100 includes a fixed outer housing 102 that partially surrounds an inner housing 104 defining a tub. The outer housing 102 includes an exterior sidewall 206 and an interior sidewall 208 extending from base 210. A waterproof shield 212 that extends from an uppermost portion of the exterior sidewall 206 may also be provided to reduce or prevent liquid escaping from the foot and lower leg treater or washer and into the surrounding environment. In one embodiment, the water-proof shield 212 is slidably engaged with one or more grooves 214 located on an inner surface 216 of the exterior sidewall 206.

The inner housing or tub 104 houses a footrest 1800 and cleaning or treating assemblies 116a-d, described in further detail below. The inner housing 104 is large enough to receive and accommodate both feet and lower legs of a user for concurrent or sequential washing or treating of a user's feet and lower legs. In another embodiment, the inner housing 104 is large enough to receive and accommodate a single foot and lower leg of a user for sequential washing or treating of one or both feet and lower legs of a user.

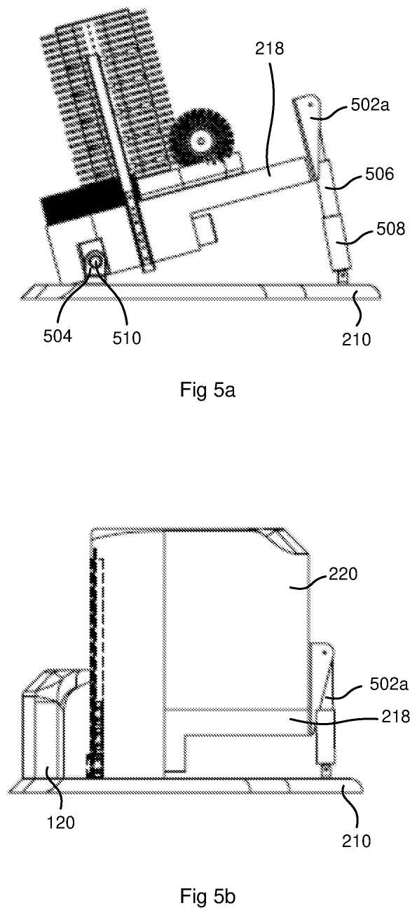

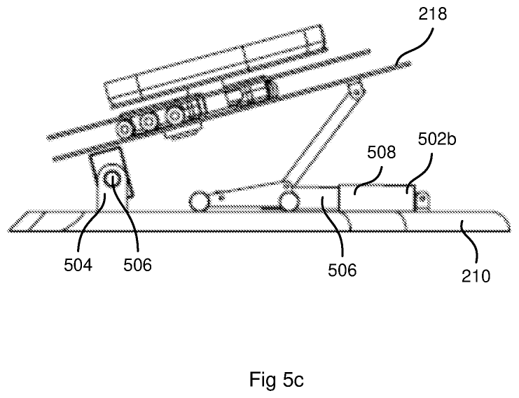

The inner housing or tub 104 may be inclined with respect to the base 210 of the outer housing 104, as shown in FIGS. 4 and 5a-5c and movable between the lowered position of FIG. 1 and the raised position of FIG. 4. The outer housing 102 and inner housing 104 may be suitably shaped and dimensioned to permit inclination of the inner housing within the outer housing. In one embodiment, the inner housing 104 may be manually inclined with respect to the base 210 of the outer housing 104 and moveable between the lower and the raised positions by the user adjusting the inner housing relative to the outer housing using their hands or feet. In the embodiment shown in FIGS. 5a-5b, one or more lifting and lowering mechanisms or rams 502a are hingedly connected to the base 210 of the outer housing 102 and a front end portion of the base 218 of the inner housing 104. In this embodiment, the interior sidewall 208 of the outer housing 102 is provided with a groove 219 such that lifting mechanism or ram 502a does not interfere with the inner housing 104 when moving between the inclined or raised configuration of FIG. 5a and the lowered or stowed configuration of FIG. 5b. In another embodiment, one or more hydraulic or pneumatic lifting and lowering mechanisms 502b are hingedly connected between the base 210 of the outer housing 104 and an underside of the base 218 of the inner housing 104. In one embodiment, the lifting and lowering mechanisms shown in FIGS. 5a-5c may be hydraulic lifting and lowering mechanisms or rams that include a piston rod 506 and a cylinder 508.

When the inner housing 104 is inclined with respect to the outer housing 102, the one or more lifting and lowering mechanisms or hydraulic rams 502a, 502b are extended towards the inclined configuration with shafts 510 provided on the base 218 of the inner housing 104 pivoting within corresponding trunnions 504 extending from the base 210 of the outer housing 102. Inclination of the inner housing 104 with respect to the outer housing 104 may provide a user with easy access to open the foot and lower leg treater or washer 100 from a seated position, together with a more comfortable and natural inclined foot and leg position once accessed through the opening. In one example, the maximum angle of inclination of the inner housing 104 with respect to the outer housing 102 is 15 degrees. In another example, the maximum angle of inclination of the inner housing 104 with respect to the outer housing 102 ranges from between 10-20 degrees. It will be appreciated that other embodiments may include intervening ranges and the angle of inclination is continuously variable between these ranges.

A support plate 222 for providing support to the inner housing 104 when in an inclined position may also be connected to the one or more shafts provided on the base 218 of the inner housing 104. When inner housing 104 is in a stowed configuration, the support plate 222 is parallel or substantially parallel to the base 218 of the inner housing 104. Inclination of the inner housing 104 with respect to the outer housing 102 causes the support plate 222 to pivot downwards on the one or more shafts 510 to engage base 210 of the outer housing 102.

As shown in FIGS. 1,4 and 6a, the inner housing is provided with a front opening 607 for providing the feet and lower legs of the user with access to the footrest. One or more slidable access doors 120 connect to opposed sidewalls 220 of the inner housing 104 for enabling a user to conveniently insert and remove their lower legs and feet through the front opening without having to raise them- they can simply swing them into position. In one embodiment, the access door 120 includes a single panel that is capable of being collapsed and expanded, for example, as a concertina fold. In one embodiment, this single panel may be made from waterproof material.

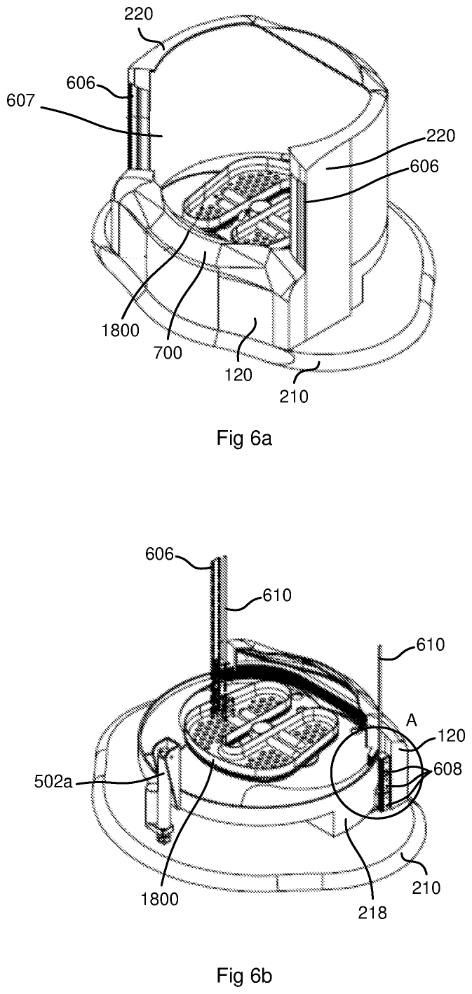

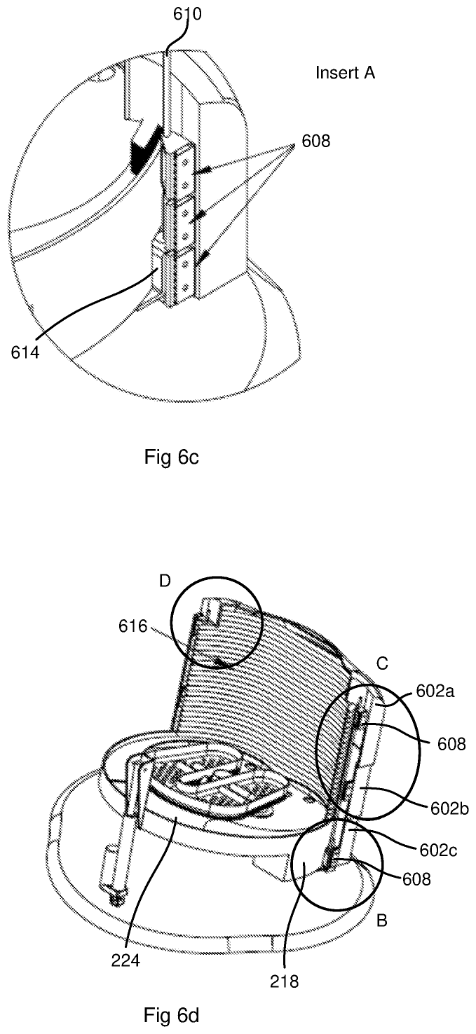

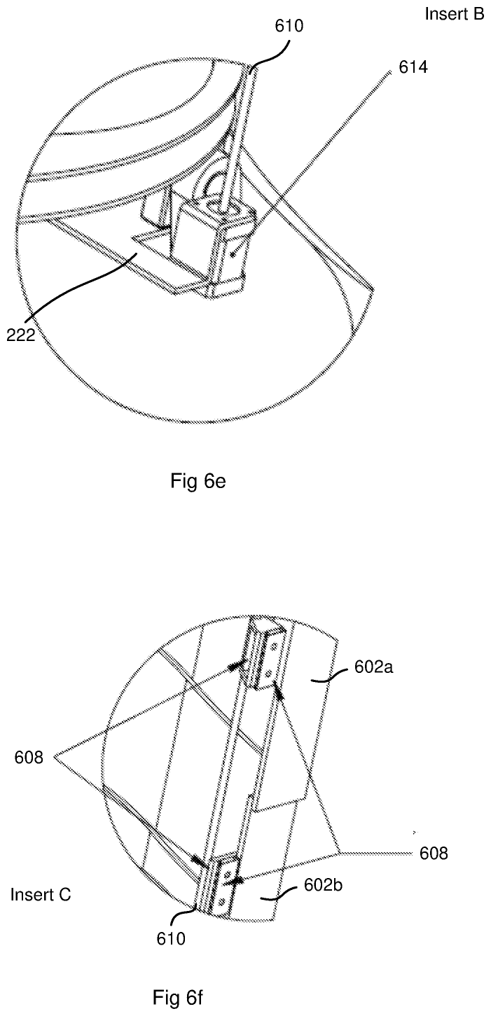

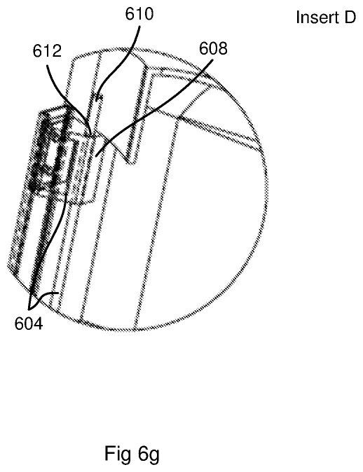

In another embodiment shown in FIGS. 6a-6f, the access door 120 includes in addition a plurality of stackable panels 602a-c connected to one or more sliding assemblies 604. Each sliding assembly 604 includes one or more sliders 608 connected to a panel 602a-c that slidably engages with one or more rails 606 provided within the sidewall 220 adjacent the front opening 607 of the inner housing 104. A threaded drive shaft 610 extends through a complementally threaded aperture 612 provided in each slider 608 whereby actuation of a motor 614 connected to the threaded drive shaft 610 causes each slider 608 to move along rails 606 as the drive shaft rotates to permit unstacking and stacking of panels 602a-c.

As shown in FIG. 6d, a waterproof panel 616 may be connected to an interior surface of the one or more rigid panels 602a-c. In the example, shown in FIG. 6c, the waterproof panel 616 is connected between the uppermost panel 602a and a base plate 224. The waterproof panel 616 may be made from flexible material that is capable of being collapsed and expanded, for example, as a concertina fold. During unstacking of panels 602a-c, the waterproof panel 616 expands to the configuration shown in FIG. 6c for preventing or minimising the egress of water from the tub.

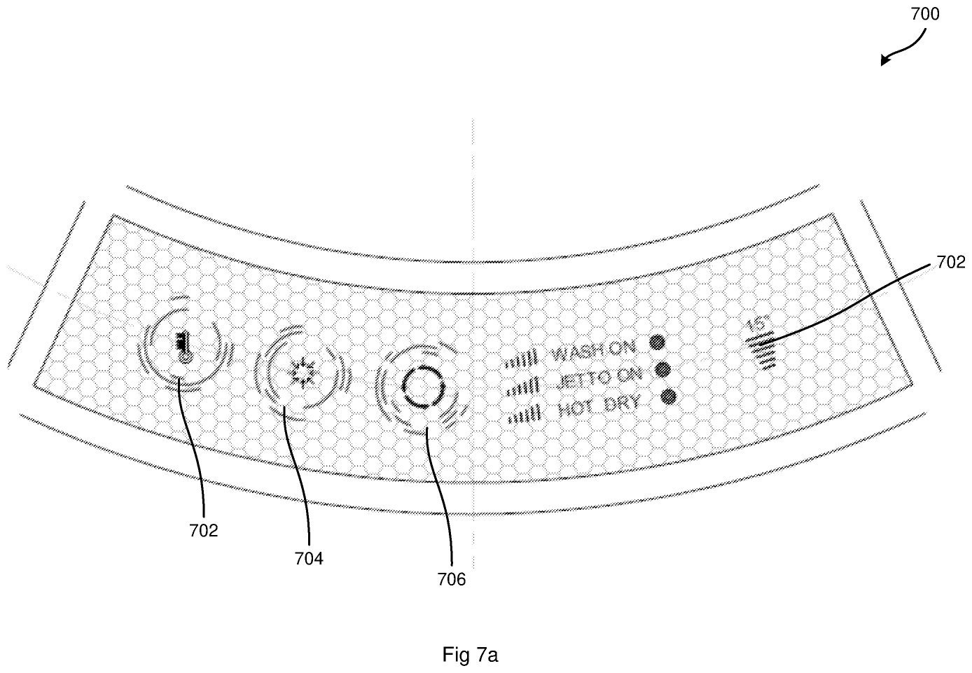

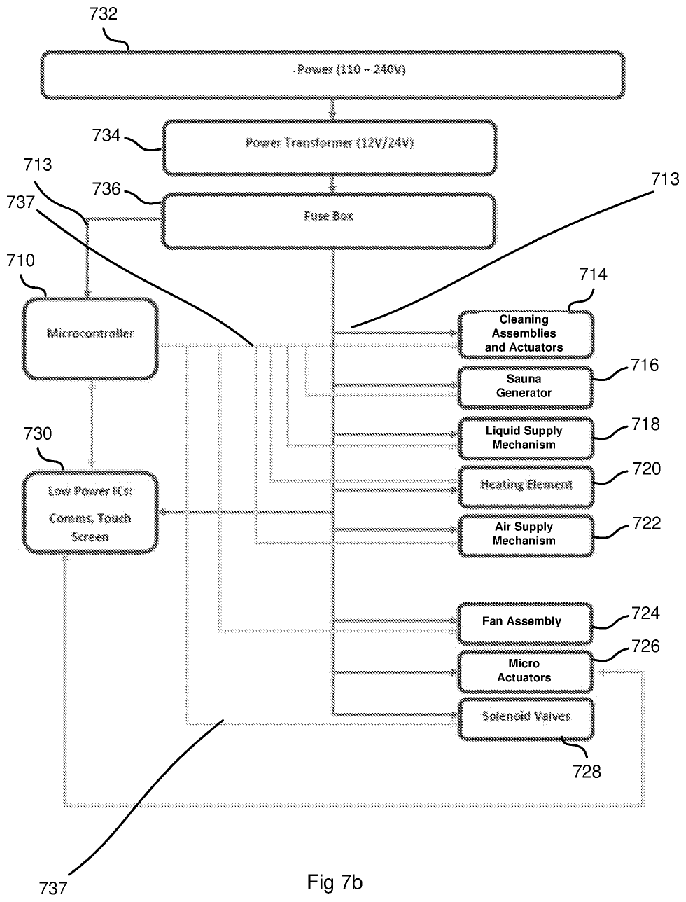

A control panel display 700 connected to a microcontroller 710 may be provided on the outer housing 102 and/or the inner housing 104. In the embodiment shown in FIGS. 1, 2, 4, 6a and 7a-7b, the control panel display 700 is provided on the uppermost stackable panel 602a for easy access by the user. The control panel display may display one or more indicators and/or controls of: water temperature 702, water intensity 704, air drying intensity 706, water pressure, inclination of the inner housing or opening/closing of the access doors, and actuation of the cleaning or treating assemblies. The microcontroller 710 is configured to control the operations or functions of the foot and lower leg treater or washer 100 as shown in FIG. 7b. The foot and lower leg treater or washer 100 includes a power supply facility 712 that connects to a controller in the form of microcontroller 710 and one or more electrical or electronic components of the foot and lower leg treater or washer 100 via power lines 713 including cleaning or treating assembly and tilt actuator motors 714, a steam generator 716, a liquid supply mechanism including a water pump 718, a heating element 720, an air supply mechanism including an air pump 722, a fan assembly 724, sensors, including micro-actuators 726 of the footrest 1800, solenoid valves 728 for controlling the flow of liquid to the cleaning or treating assemblies. Power is also supplied to low power integrated circuits 730 for controlling the operation of the touch screen control panel display 700 and for controlling transmitters/receivers to wirelessly communicate with an external party or wirelessly communicate with mobile electronic devices such as smart phones. In one embodiment, the power facility 712 includes a power supply 732 such as battery or mains power, a transformer 734 and a fuse box 736.

The microcontroller may be configured to control the operation of one or more of: water temperature, water intensity, water pressure, air drying intensity, inclination of the inner housing or opening/closing of the access doors , and cleaning or treating assemblies via control lines 737 linked to the aforementioned components. In another embodiment, the controller may control the rotation speed and rotary motion of the cleaning or treating assemblies. Bidirectional control lines also extend between the microcontroller 710 and the communications and touch screen circuits 730 as well as sensors 726. It will be appreciated that the control lines may be wired or wireless using an appropriate wireless protocol such as Bluetooth or wireless LAN (IEEE802.11) or RF.

The microcontroller 710 may be operated via the control panel 700 as well as or alternatively via a remote controller which may be implemented in an app on a smart phone for example or a dedicated remote controller which may provide the user with a suitable touchscreen control interface. It will be appreciated that elements of the microcontroller may also be implemented remotely on a remote control device or app which transmits control signals to the various components of the foot and lower leg treater or washer, and receives input signals from the foot and lower leg treater or washer. The controller may include various programmable washing or treating routines which can selected by the user.

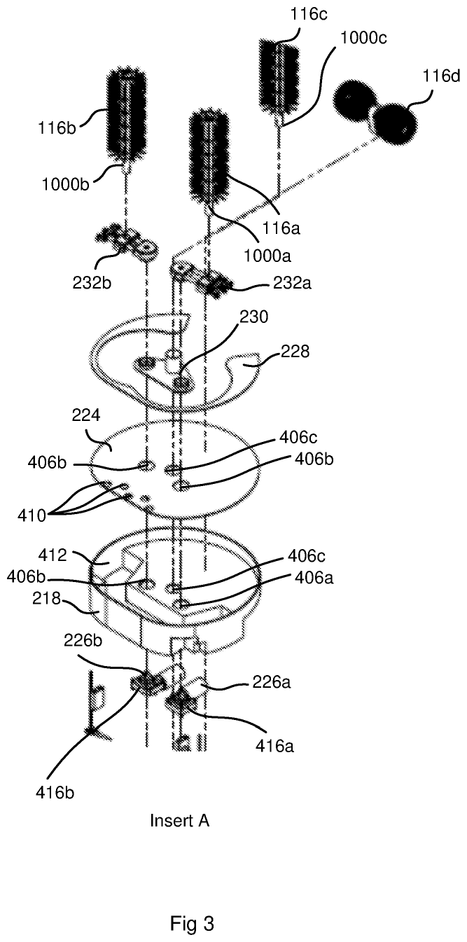

As shown in FIG. 3, the base 218 of the inner housing 104 includes a hull 218 located below a base plate 224. The hull 218 and base plate 224 are provided with one or more apertures 406 for connecting one or more cleaning or treating assemblies 116a-d to one or more motors located on an underside of the hull 218 and/or supporting the one or more cleaning or treating assemblies 116a-d in an upright and/or transversely extending orientation. In the example shown in FIG. 3, apertures 406a and 406b in the hull 218 and the base plate 224 connect cleaning or treating assemblies 116a and 116b to actuators 226a and 226b, while aperture 406c in the hull 218 and the base plate 224 supports cleaning or treating assembly 116c in an upright orientation.

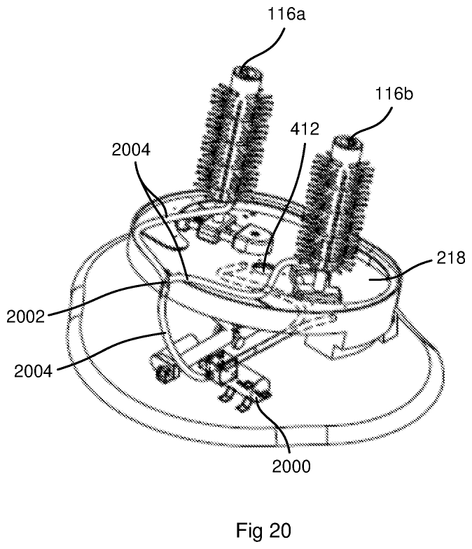

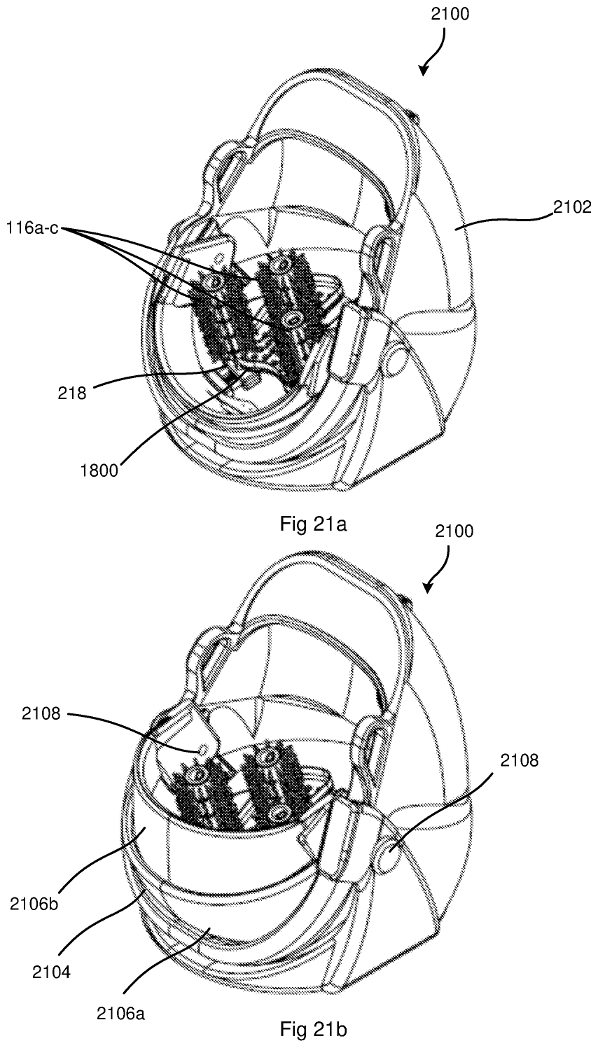

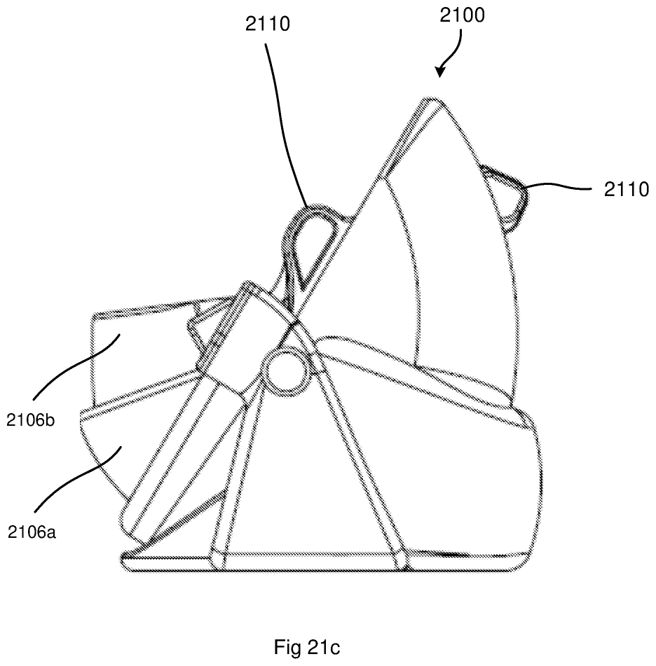

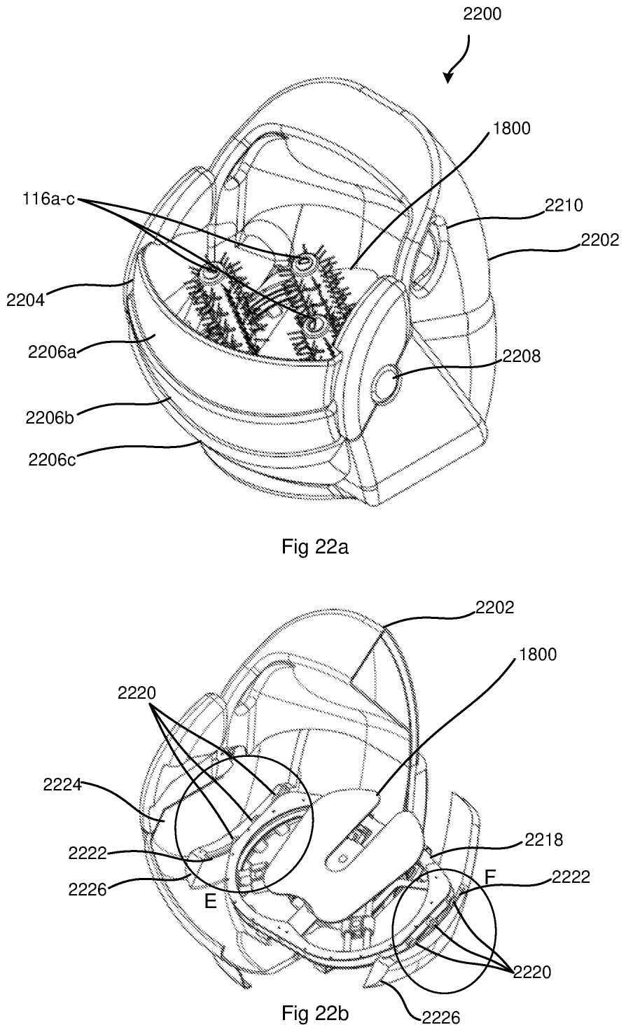

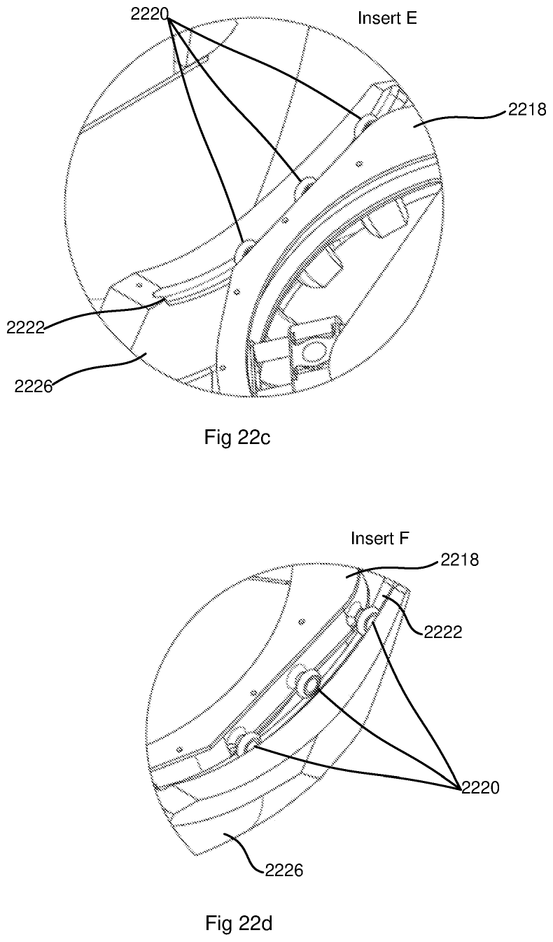

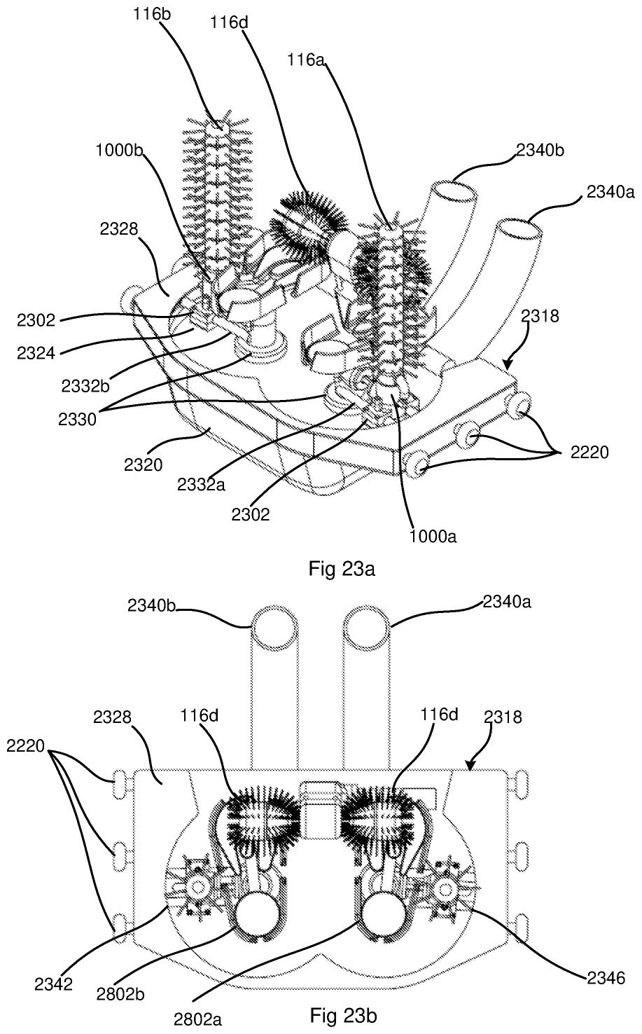

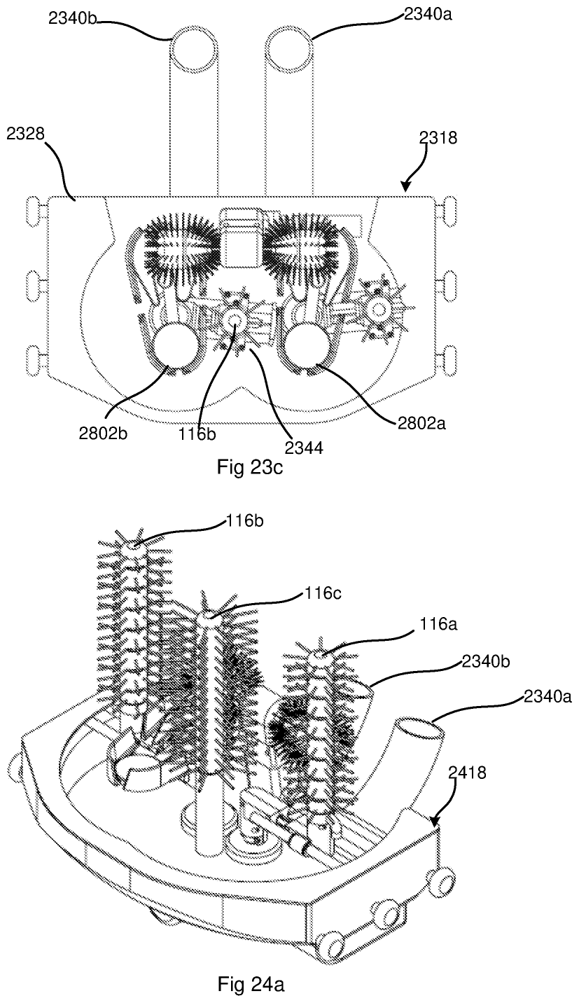

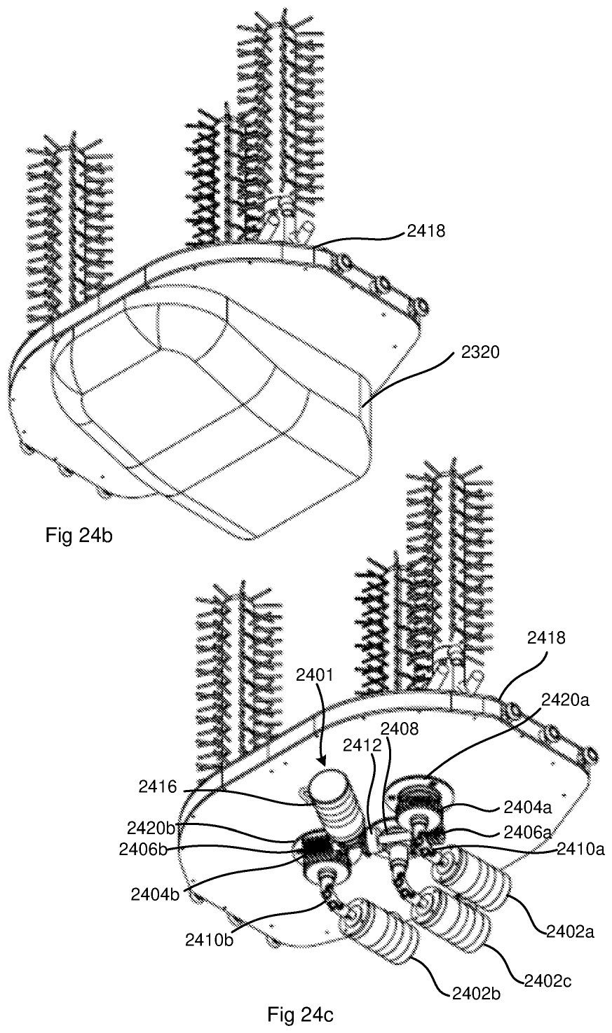

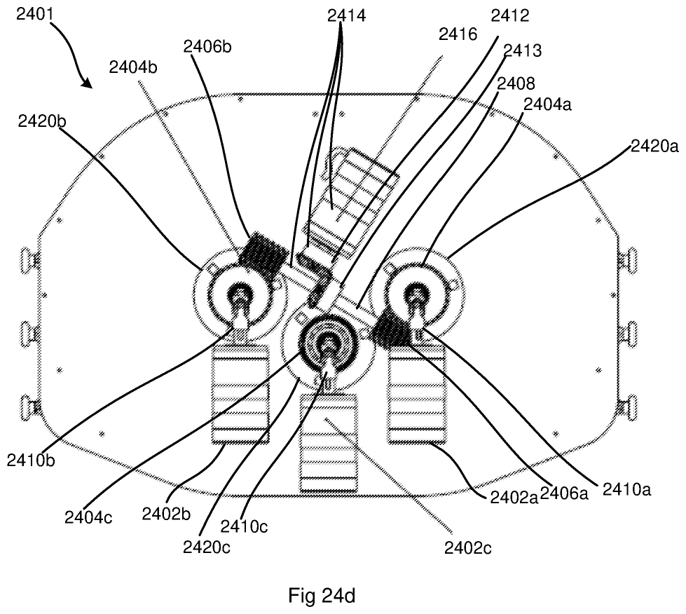

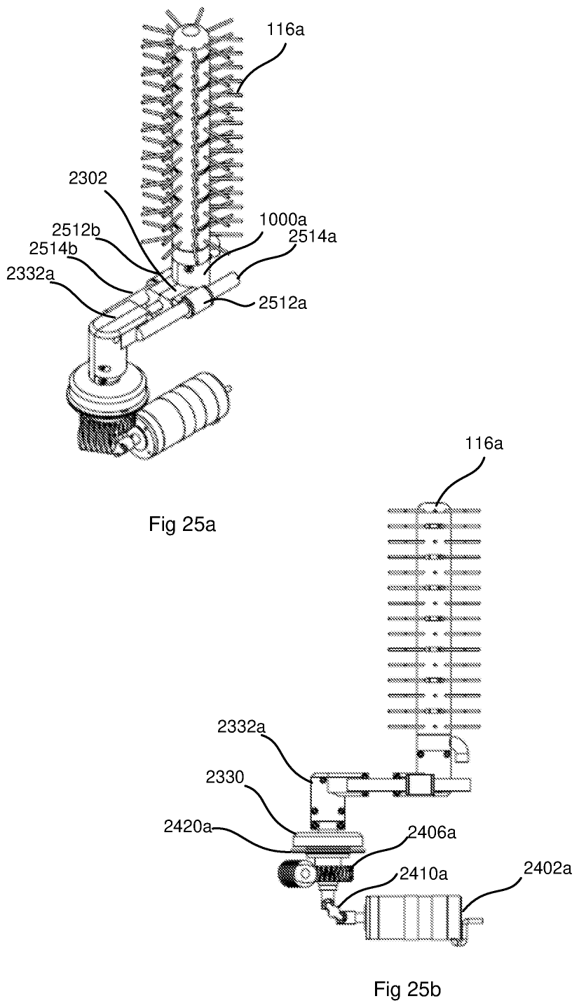

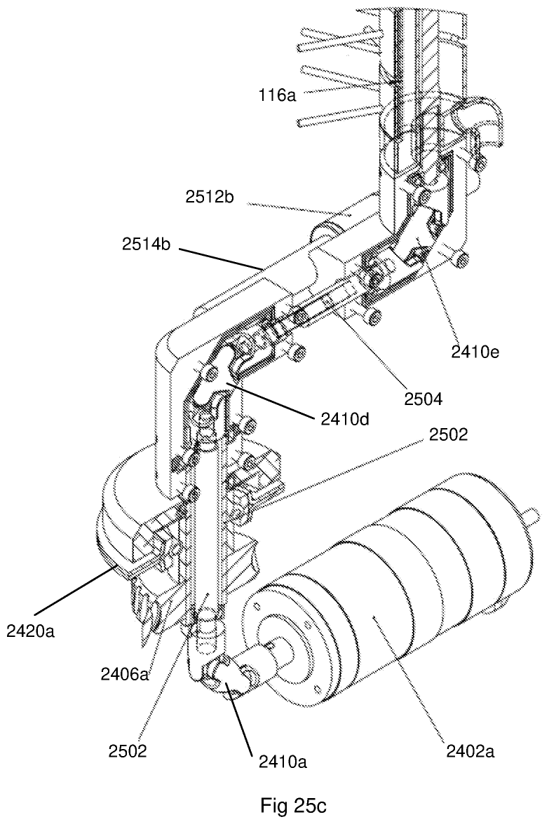

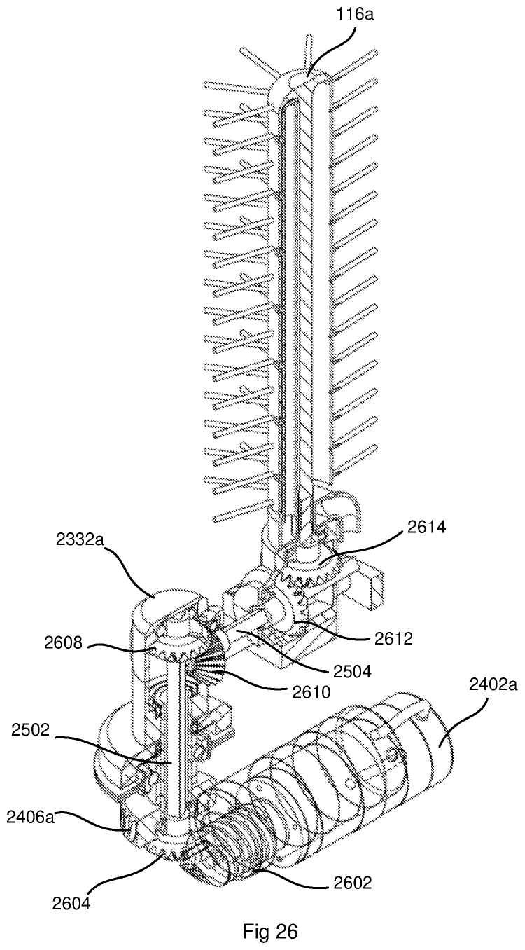

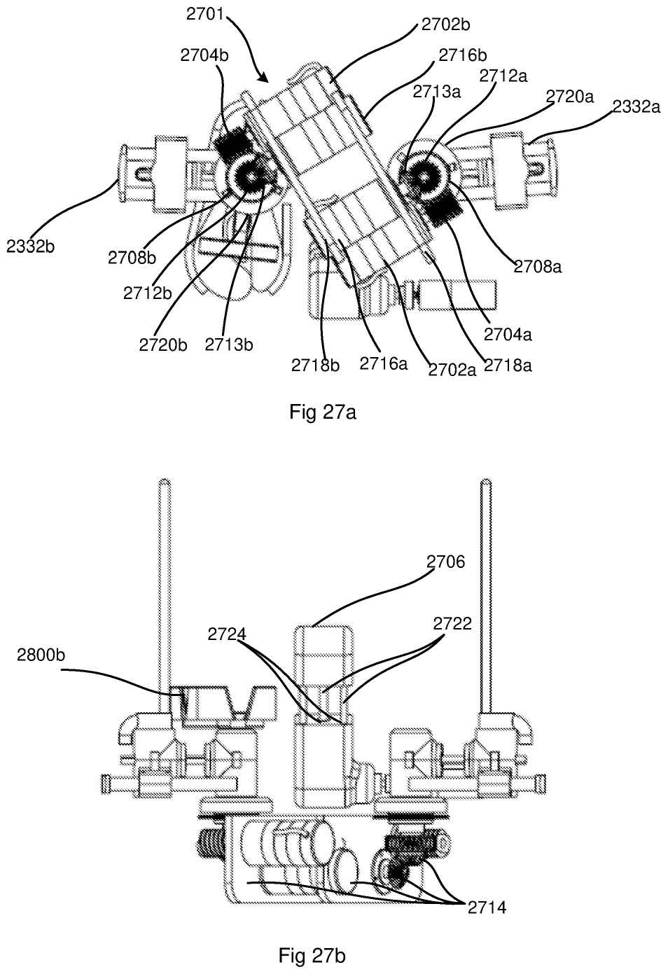

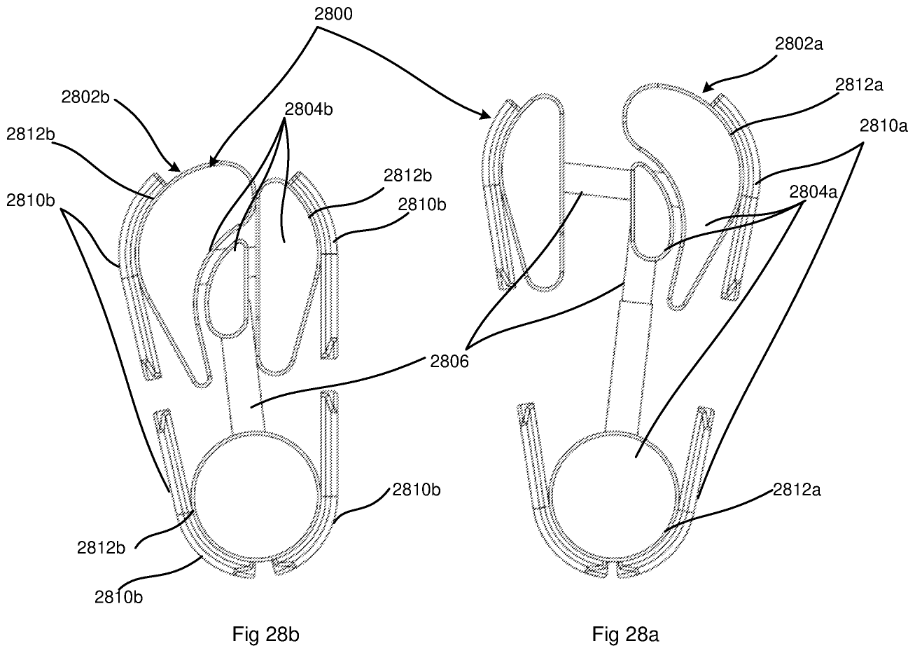

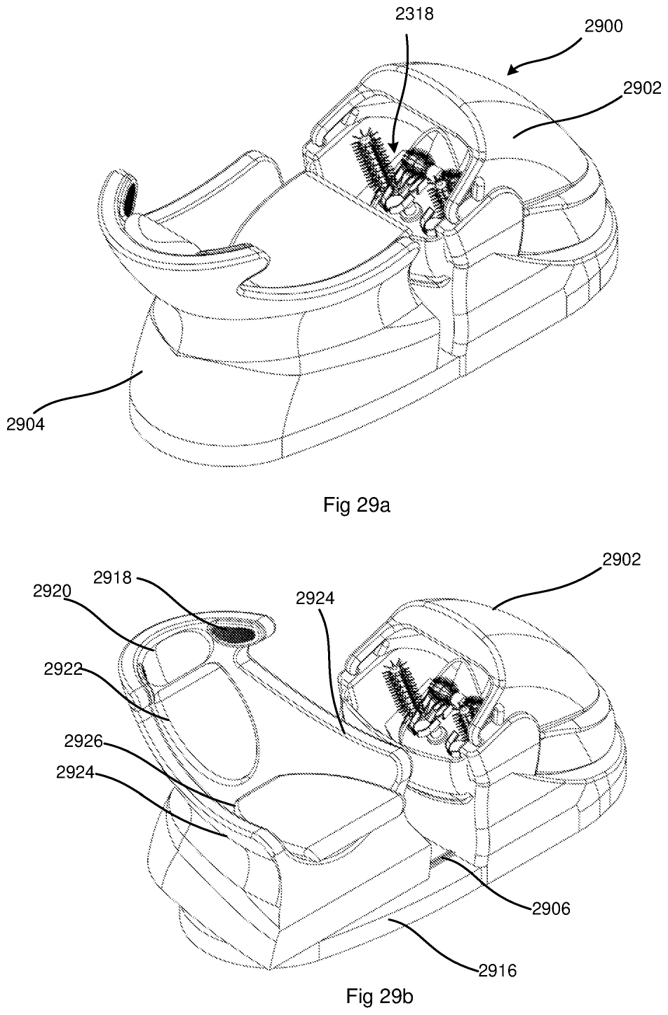

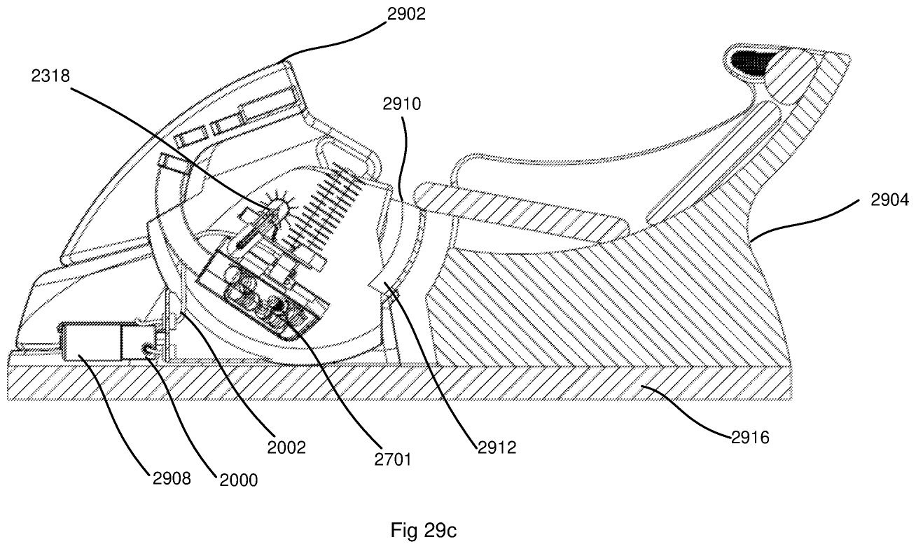

The base plate 224 may be provided with one or more apertures 410 for draining liquid from the foot and lower leg treater or washer 100 into a tank 412 located in the hull 218. As shown in FIG. 20, a pump 2000 may be located below the hull 218 and configured to pump liquid stored in the tank 412 and to a fluid supply mechanism 2002 for directing liquid to the one or more cleaning or treating assemblies 116a-d. In an embodiment, the liquid in the inner housing 104 can be recirculated by the pump 2000 pumping liquid from the tank 412 through an outlet located in the tank. The pump 2000 may also pump waste liquid from the inner housing 104 and into the tank 412 for later disposal. In one embodiment, a heating element is provided below the tank 412 and connected to power supply 732 for heating liquid stored in the tank 412. In another embodiment, the heating element is provided within the tank 412. The heating element may heat the liquid stored in the tank 412 until steam is generated. The generated steam is then directed by one or more pipes to one or more outlets provided in the base plate 224 and/or the inner housing 104. In another embodiment, steam is generated from a steam generator assembly including a tank and a heating element provided on an upper surface of the base plate 224. Liquid may be pumped via channels from the tank 412 to the tank of the steam generator assembly. The steam generator assembly may include one or more outlets for outputting steam into the inner housing.

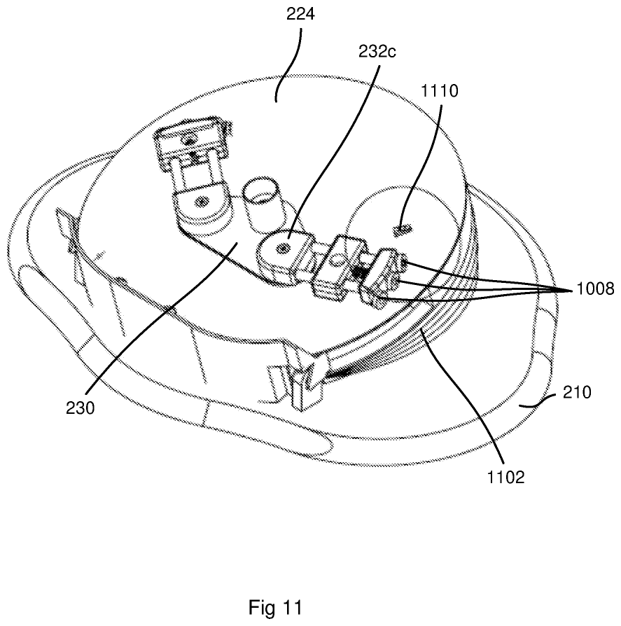

In one embodiment, the fluid supply mechanism 2002 may also direct air from an air supply source to the one or more cleaning or treating assemblies 116a-d. As shown in FIG. 20, the fluid supply mechanism includes one or more flexible tubes 2004 for supplying liquid and/or air to the one or more cleaning or treating assemblies 116a-116d and/or the footrest 1800. In one embodiment shown in FIG. 11, the base plate 224 may also be connected to a waterproof concertina screen 1102 that expands in response to inclination of the base 218 to minimise or prevent liquid from entering the cavity located below the hull 218 that stores the pump and/or actuators 226a and 226b of the cleaning or treating assemblies 116a-116b.

The foot and lower leg treater or washer 100 may include one or more rotatable upright cleaning or treating assemblies 116a-c and/or one or more rotatable transversely extending cleaning or treating assemblies 116d. In one embodiment, the one or more rotatable upright cleaning or treating assemblies 116a-c are connected to the base plate 224 of the inner housing 104 via holder 230. The one or more rotatable upright cleaning or treating assemblies may be fixed in relative to a portion of the footrest 1800 or configured to move around a portion of the footrest 1800 during a lower leg and foot cleaning cycle. In one embodiment shown in FIGS. 3 and 8-9, the foot and lower leg treater or washer 100 includes: two rotatable upright cleaning or treating assemblies 116a-116b that move around a portion of the footrest 1800 during a lower leg and foot cleaning cycle; one fixed intermediate rotatable upright cleaning or treating assembly 116c ; and a rotatable transversely extending cleaning or treating assembly 116d. The fixed intermediate rotatable upright cleaning or treating assembly 116c may be suitable for washing, treating or massaging an inner portion of a user's lower leg 908 and the two rotatable upright cleaning or treating assemblies 116a-116b that move around a portion of the footrest 1800 may be suitable for washing, treating or massaging an exterior portion of a user's lower leg, while the rotatable transversely extending cleaning or treating assembly 116d may be suitable for washing, treating or massaging the user's feet. In another embodiment, the foot and lower leg treater or washer 100 includes a single rotatable transversely extending cleaning or treating assembly for washing or treating a user's feet and a single rotatable upright cleaning or treating assembly for washing or treating one or both lower legs and feet of a user.

The operation of one or more upright cleaning or treating assemblies 116a-c may occur concurrently or sequentially with the operation of the one or more transversely extending cleaning or treating assemblies 116d. The operation of the one or more upright cleaning or treating assemblies 116a-c may alternatively occur without operation of the one or more transversely extending cleaning or treating assemblies 116d. In yet another mode, the one or more transversely extending cleaning or treating assemblies 116d operate without the operation of the upright cleaning or treating assemblies 116a-c.

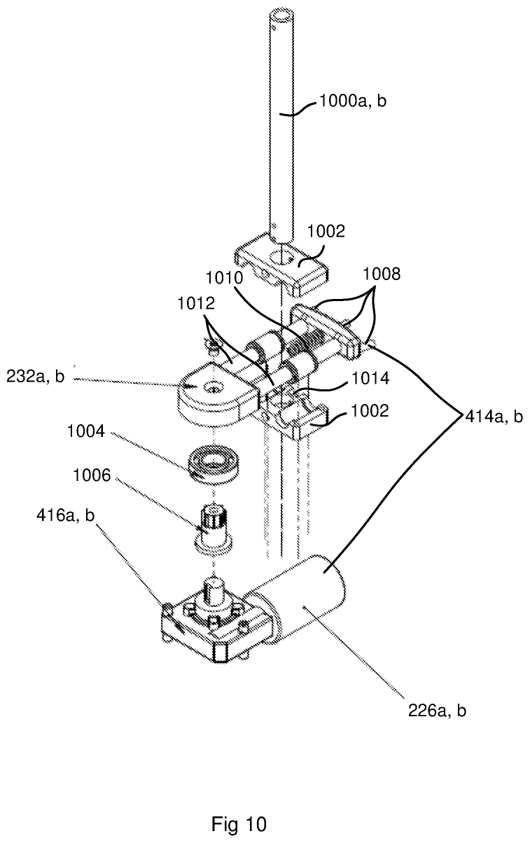

As shown in FIGS. 3 and 10, the rotatable upright cleaning or treating assemblies 116a-b are arranged on rotatable upright shafts 1000a-b that are connected to a guiding mechanism 414a,b by one or more support clamps 1002. Each guiding mechanism 414a,b includes an actuator 226a,b in the form of a brushless motor that drives a transmission mechanism 416a,b for pivoting rotary arm 232a,b on bearing 1004 and adaptor 1006 and driving one or more wheels 1008 of the rotary arm 232a,b around a track of guiding plate 228 that surrounds a portion of the footrest 1800. In one embodiment, the wheels 1008 of the rotary arm 232a,b and track of the guiding plate 228 are a rack and pinion arrangement.

In one embodiment, the rotatable upright cleaning or treating assemblies 116a-116c are linearly and dynamically adjustable to accommodate variations in size and profile of a user's lower legs and feet. In one embodiment, the rotatable upright cleaning or treating assemblies 116a-116b that move around a portion of the footrest are dynamically adjustable by a biasing means for biasing the one or more upright cleaning or treating assemblies against one or more lower legs of a user thereby to accommodate different lower leg profiles. In one embodiment, the biasing means is a spring 1010 and piston 1012 arrangement located on the rotary arm 232a,b. In one example, extension of rotary arm 232a,b will cause pistons 1012 to extend and spring 1010 to compress against cut outs 1014 in support beams 1002.

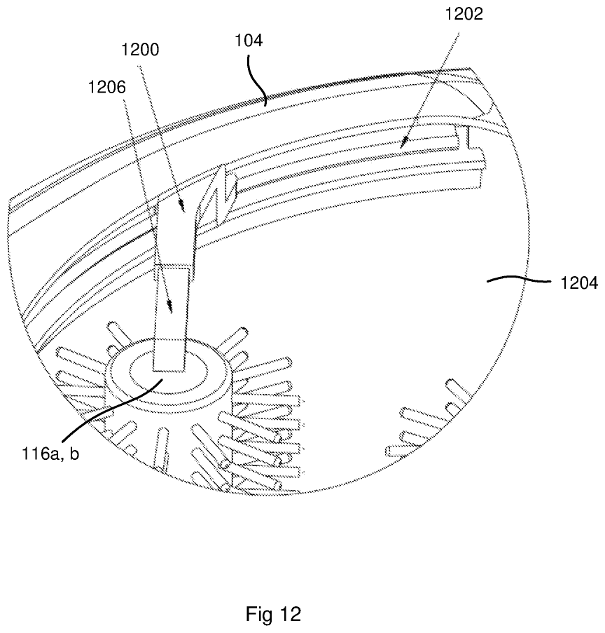

In another embodiment, each rotatable upright cleaning or treating assembly 116a-116c is connected at its uppermost portion to an expandable joint 1206 of an adjustable adaptor 1200 that engages a rail 1202 provided on an inner surface 1204 of the inner housing 104. As shown in FIG. 12, each rotatable upright cleaning or treating assembly 116a-116b is connected at its uppermost portion to an adjustable adaptor 1200 that slidably engages a rail 1202 provided on an inner surface 1204 of the inner housing 104 for facilitating movement of the cleaning or treating assemblies 116a-116b around portion of footrest 1800 and accommodating a user's lower legs and feet.

In another embodiment shown in FIG. 12, each rotatable upright cleaning or treating assembly 116a-116c is connected at its uppermost portion to an adjustable adaptor 1200 that slidably engages a rail 1202 provided on an inner surface 1204 of the inner housing 104 for facilitating movement of the cleaning or treating assemblies 116a-116b around portion of footrest 1800 and accommodating a user's lower legs and feet.

The actuators 226a,b of the rotatable upright cleaning or treating assemblies 116a-b may be in the form of a motor, for example, a fluid immersible electric motor and the transmission mechanisms 416a,b of the rotatable upright cleaning or treating assemblies 116a-116b may be a gear box, for example, a fluid immersible worm gear box.

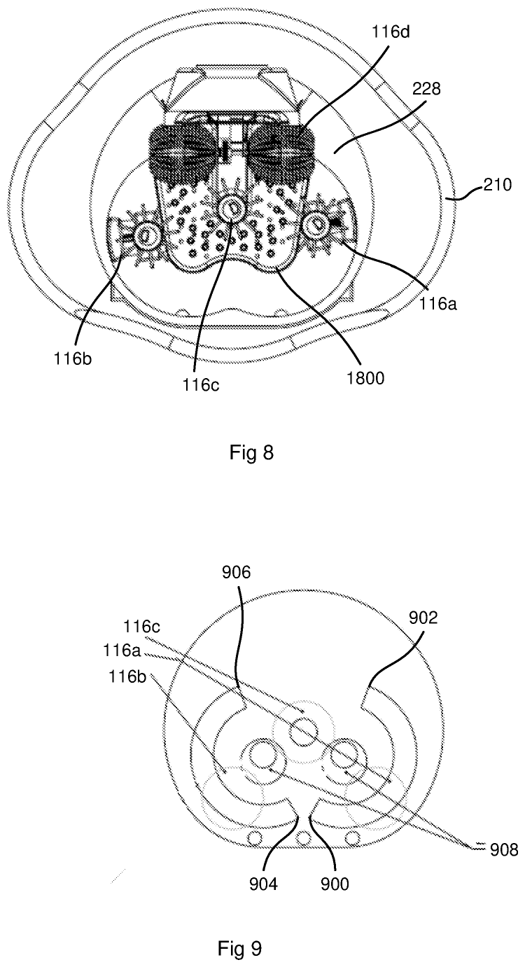

In the instance where two or more upright cleaning or treating assemblies are used, the guiding mechanism can operate these assemblies either concurrently or sequentially. In the two brush embodiment shown in FIGS. 8-9, the rotatable upright cleaning or treating assembly 116a is configured to wash and/or massage a user's lower right leg and foot by moving from a first position 900 adjacent to a middle portion of the footrest 1800 to a second position 902 adjacent to the right side of the footrest 1800 and return to the first position 900 once limit switch 1100 has been contacted. In addition, the rotatable upright cleaning or treating assembly 116b is configured to wash and/or massage a user's lower left leg and foot by moving from a first position 904 adjacent to a middle portion of the footrest 1800 to a second position 906 adjacent to the left side of the foot rest and return to the first position 904. In an embodiment where a single upright brush is used, the upright brush is configured to wash and/or massage a user's lower legs and feet by moving from a first position adjacent to the left or right side of a footrest to an intermediate position located between the user's lower legs and feet and to a second position located adjacent to the right or left side of the footrest, respectively, before returning to the first position via the intermediate position.

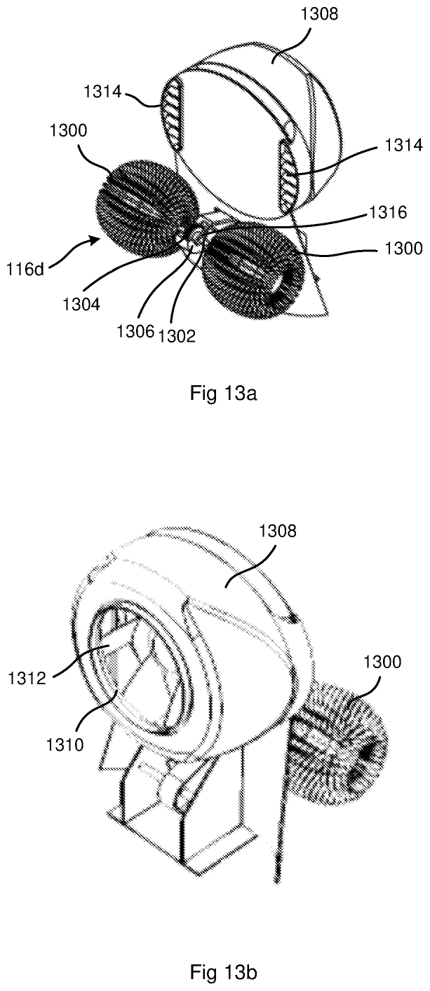

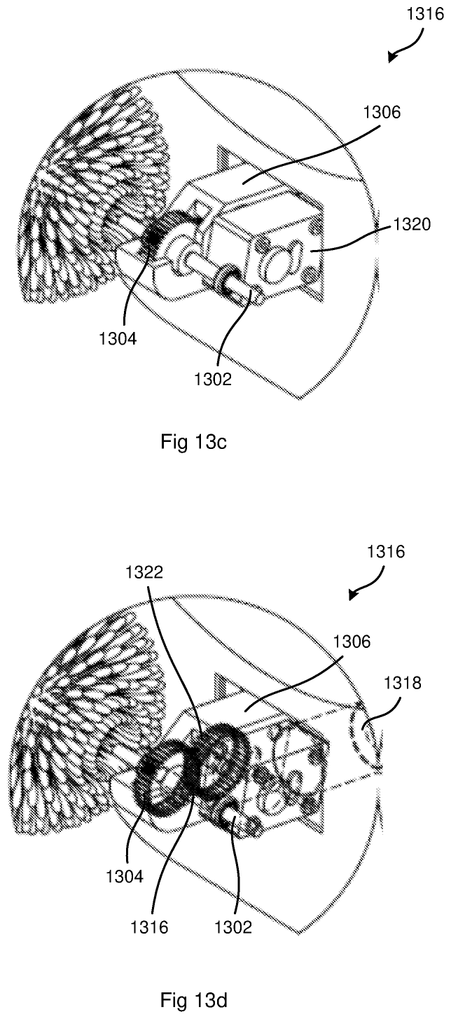

As shown in FIGS. 13a-13b, each transversely extending cleaning or treating assembly 116d comprises one or more brush attachments 1300 located on a transversely extending shaft 1302 above the footrest 1800. The transversely extending shaft 1302 has a drive mechanism 1316 that includes a wheel 1304 located in housing 1306. The configuration of the drive mechanism 1316 may permit a user to adjust the height of the transversely extending cleaning or treating assembly by applying pressure on the brush attachments with their feet. An actuator 1318 drives the wheel 1304, the transversely extending shaft 1302 and brush attachments 1300 and a transmission mechanism 1320 including a gear 1322 that transmits the rotary motion to the shaft 1302. In another embodiment, each transversely extending cleaning or treating assembly is configured to be driven by the actuator along a track disposed parallel to the footrest 1800 in order to wash the user's feet. In one embodiment the drive mechanism 1316 is a damped rotation joint.

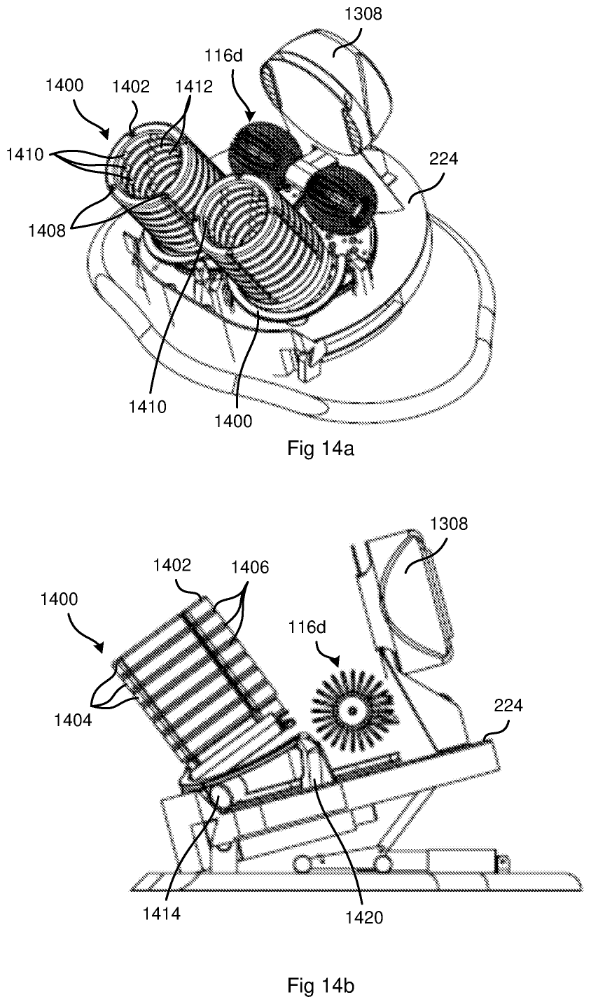

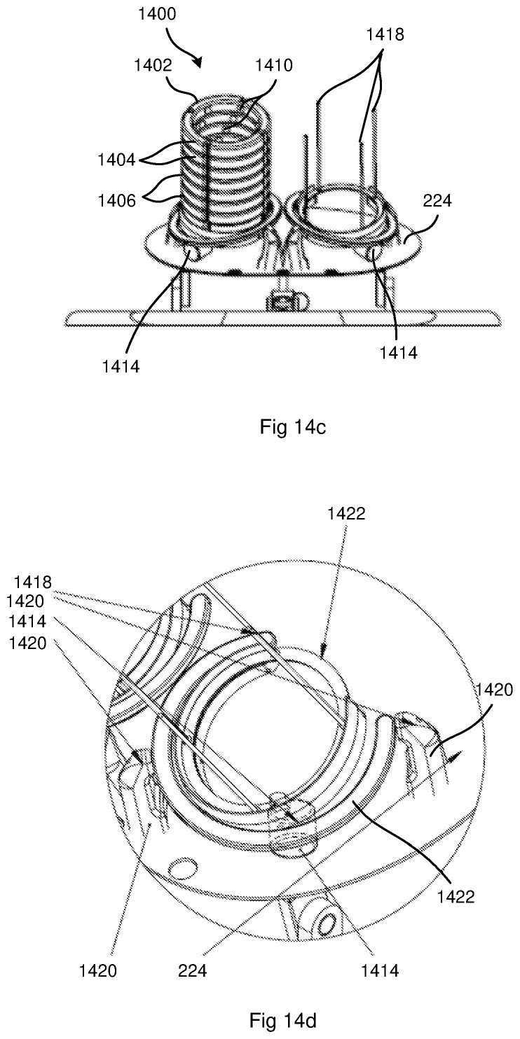

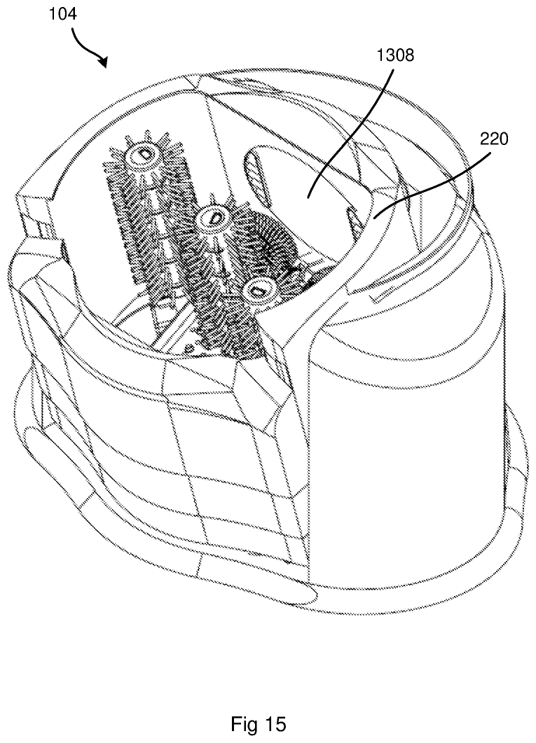

In the embodiment shown in FIGS. 13a-13b and 14a-14b, the transversely extending cleaning or treating assembly 116d is connected to a fan assembly 1308 extending from an upper surface of base plate 224. In another embodiment shown in FIG. 15, the fan assembly 1308 may be provided in sidewall 220 of the inner housing 104. The fan assembly 1308 may be used concurrently or independently of the upright cleaning or treating assemblies 116a-c and/or transversely extending cleaning or treating assembly 116d to dry and/or cool a user's feet and lower legs. In the example shown in FIGS. 13a-13b, air enters the fan assembly 1308 through opening 1310 shown in FIG. 13b where fan 1312 directs the air to heating element (not shown) and through vents 1314 where it is then expelled into inner housing 104 for drying a user's feet and lower legs.

The one or more rotatable transversely extending cleaning or treating assemblies 116d or the one or more rotatable upright cleaning or treating assemblies 116a-c may include one or more of: a rotary coil attachment 1400; a rotary brush attachment 1600; a rotary sponge attachment 1700; a liquid jet attachment; or an air dryer attachment. The rotary coil, massage, brush, sponge, liquid jet or air dryer attachments may be removable and interchangeable. The rotary motion of the one or more transversely extending or upright cleaning or treating assemblies may also be selectively controlled in an either a clockwise or an anticlockwise motion.

It will also be appreciated that any combination and number of interchangeable rotary coil, brush, sponge, liquid jet or air dryer attachments can be used. For example, a rotary coil attachment may operate on the right upright cleaning or treating assembly, while a rotary brush attachment may operate on the left upright cleaning or treating assembly.

An example of a rotary coil attachment 1400 for washing and/or treating a user's lower legs and feet is shown in FIGS. 14a-b. The rotary coil attachment 1400 includes a cylindrical housing 1402 having a series of hollow concentric tubes 1404 separated by grooves 1406. The rotary coil attachment 1400 is connected to an actuator 1414 and a transmission mechanism 1422 that transmits rotary motion to the coil attachment 1400.

The rotary coil attachment 1400 is connected to a fluid supply mechanism 2002 that dispenses liquid and/or or air through a series of apertures 1408 provided in the series of hollow concentric tubes 1404 for washing and/or drying the lower legs and feet of a user. In one embodiment, the rotary coil attachment 1400 is inflatable by the air supply mechanism for expanding around user's lower legs and feet. In one embodiment, the rotary coil attachment 1400 is inflatable along one or more rails 1418 that extend through the cylindrical housing 1402 and are configured to rotate with rotation of the rotary coil attachment 1400. A lower most coil 1422 of the rotary coil attachment 1400 is connected to one or more supports 1420 for supporting the rotary coil attachment 1400 during inflation and rotation. It will be appreciated that inflation of the rotary coil attachment 1400 may accommodate the lower legs and feet of various users that have different sizes and/or dimensions. In one embodiment, the rotary coil attachment 1400 may be made from flexible material for expanding and/or contracting around a user's lower legs and feet and for permitting inclination of the rotary coil attachment 1400 relative to the base plate 224.

Rotary coil attachment 1400 is provided with one or more balls 1410 located on an interior surface 1412 of each groove 1406 for massaging a user's lower leg. The rotary motion of the one or more balls 1410 of the rotary coil attachment 1400 may also improve blood circulation in the user's lower legs and feet. In one embodiment, the coil attachment 1400 may also be connected to an inclination mechanism (not shown) for inclination of the rotary coil attachment 1400 relative to the base plate 224. The inclination of the rotary coil attachment 1400 may be performed independently or concurrently with the inclination of the inner housing 104.

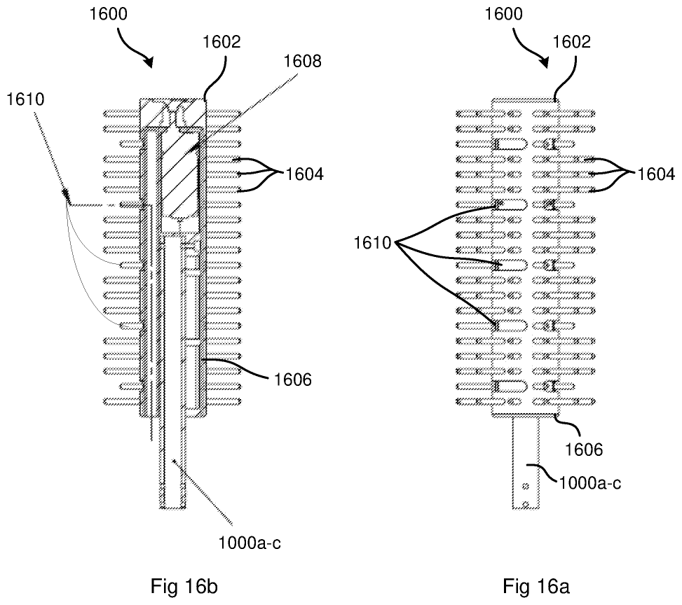

An example of a rotary brush attachment 1600 is shown in FIGS. 16a-b and includes a brush 1602 including a plurality of bristles 1604 located on an upright manifold 1606. The manifold 1606 houses an actuator 1608 connected to a rotatable upright shaft 1000a-c for rotating the cleaning or treating assemblies 116a-c. The manifold 1606 is provided with a passage 1608 for directing liquid and/or air from the fluid supply mechanism 2002 through a plurality of apertures 1610 of the brush attachment 1600.

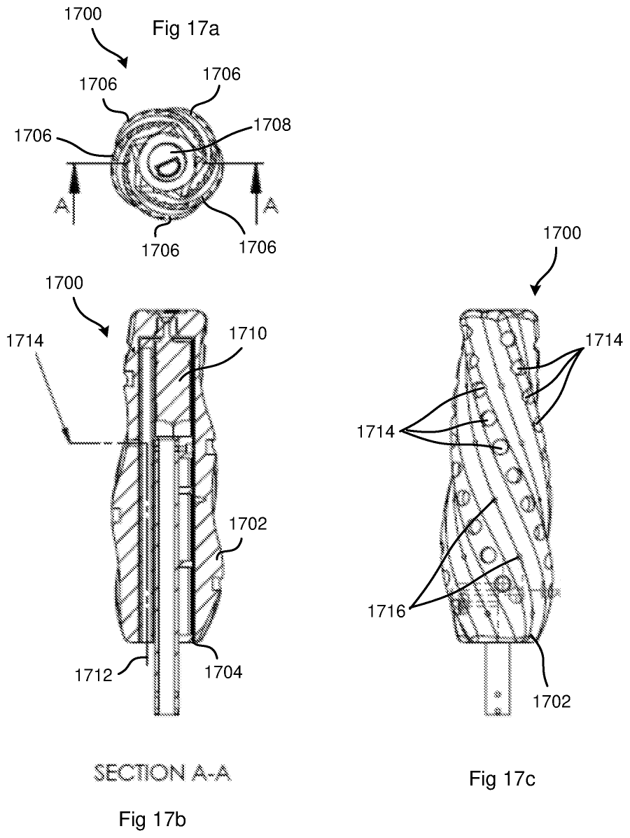

An example of a rotary sponge attachment 1700 is shown in FIGS. 17a-17c and includes a sponge 1702 located on an upright manifold 1704. Sponge 1702 is provided with a series of concentric flanges 1706 arranged in a spiral configuration that emanate from central core 1708. The manifold 1704 houses an actuator 1710 connected to a rotatable upright shaft 1000a-c for rotating the cleaning or treating assemblies 116a-c.

The manifold 1710 is provided with a passage 1712 for directing liquid and/or air from the fluid supply mechanism 2002 through a plurality of various sized apertures 1714, 1716 of the sponge attachment 1700.

In another embodiment, the plurality of bristles 1604 or sponge 1702 forming the transversely extending or upright cleaning or treating assemblies 116a-d are removable to expose each transversely extending or upright manifold 1606, 1704 that contains a plurality of apertures 1610, 1714 disposed thereon. Pressurised liquid is capable of being dispensed through each of these transversely extending or upright manifolds 1606, 1704 in order to provide a washing and/or massaging action to the user. Compressed air is also capable of being dispensed through each of the transversely extending or upright manifolds 1606 in order to dry a user's feet and lower legs.

Each transversely extending or upright cleaning or treating assembly 116a-c is connected to the fluid supply mechanism 2002 and, in one mode, configured to dispense liquid through a manifold and the cleaning or treating assembly for washing one or both feet and lower legs of a user. In another mode, each transversely extending or upright cleaning or treating assembly 116a-c is connected to the air supply mechanism and, in one mode, configured to dispense compressed air through a manifold and the cleaning or treating assembly for drying one or both feet and lower legs of a user.

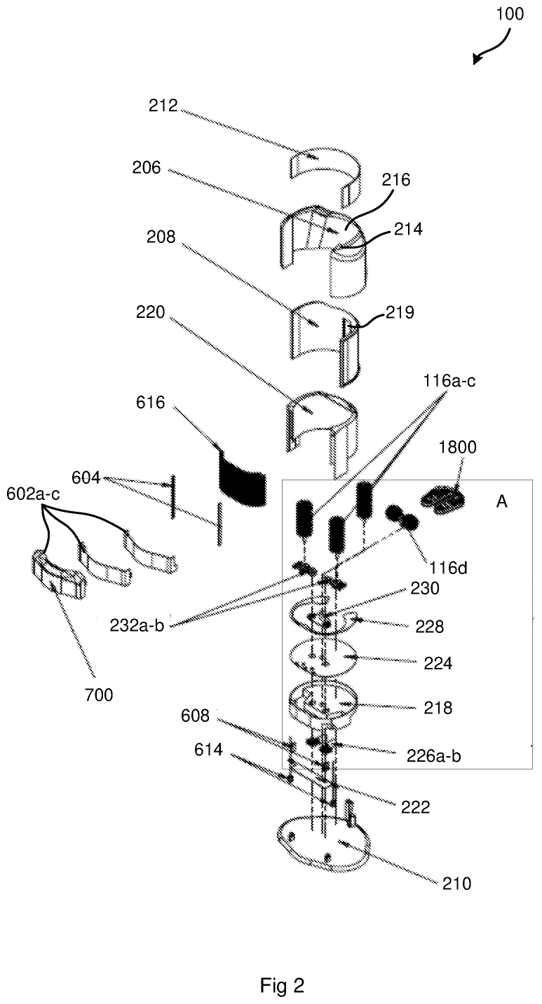

As shown in FIGS. 2, 6a, 6c, 8 and 18, a footrest 1800 is located within inner housing 104 and is capable of receiving both feet of the user. In another embodiment, a footrest 1800 may be provided for each foot and lower leg of the user, The footrest 1800 may also aid in maintaining and supporting the user's feet and lower legs in a predetermined position during washing and/or treatment. The footrest 1800 may be coated in a non-slip coating to prevent slippage and aid in the stability of the user during washing of their feet and lower legs.

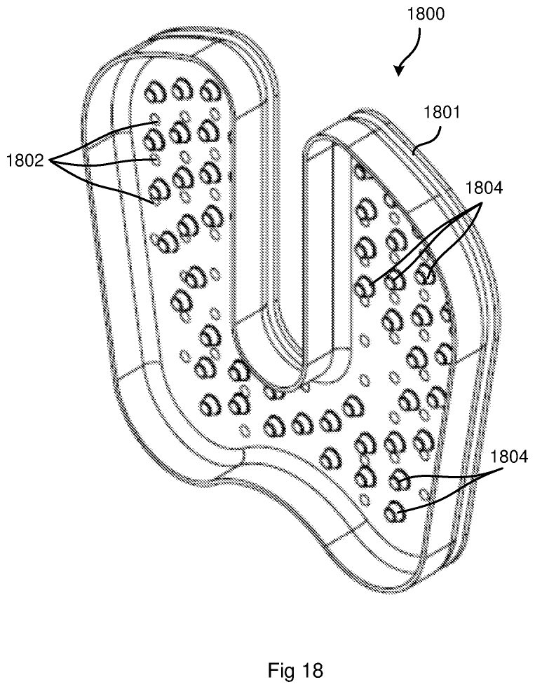

In the embodiment shown in FIG. 18, the footrest 1800 includes a support plate 1801 having an array of micro actuators 1802, 1804. The array of micro actuators 1804 are connected to the controller for detecting the size and/or dimensions of a user's feet, while the array of micro actuators 1802 apply specific pressures to the under side of a user's feet. The controller determines the size and/or dimensions of a user's feet by determining the degree of compression of each micro actuator 1804. For example, no compression of an actuator 1804 relative to the support plate 1801 will correspond to an area of the footrest 1800 where the user has not placed their feet. In contrast, compression of an actuator 1804 relative to the support plate 1801 will correspond to an area of the foot rest 1804 where the user has placed their feet. Various degrees of compression of a micro actuator 1804 relative to the support plate 1801 will also permit determinations of the distance of the user's foot relative to the support plate 1801. For example, lower levels of compression of a micro actuator 1804 relative to the support plate 1801 may correspond to the foot arch of a user whereas greater levels of compression of a micro actuator 1804 may correspond to the heal or palm of a user's foot. The controller may use the size and/or dimensions of the user's feet to apply specific pressure or vibrations to a user's feet via micro actuators 1802.

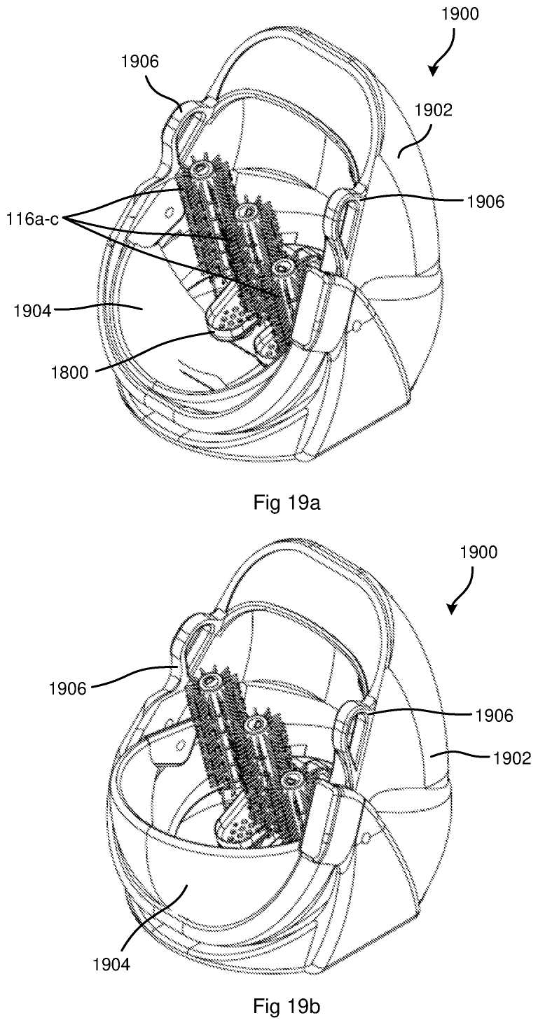

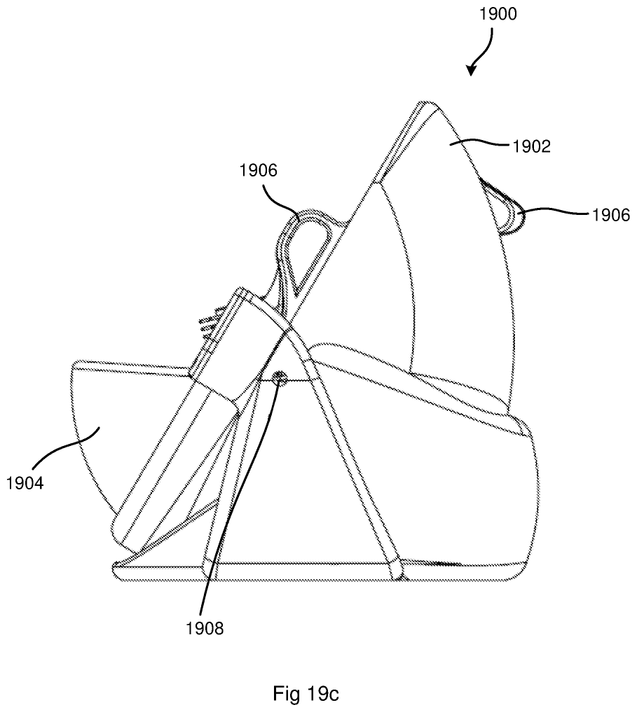

FIGS. 19a-19c show a second embodiment of a foot and lower leg treater or washer 1900. The foot and lower leg treater or washer 1900 includes a similar structure of the footrest 1800, base 218 of the inner housing 104 and cleaning or treating assemblies 116a-d as those described above for the first embodiment. The foot and lower leg treater or washer 1900 includes an outer housing 1902 and an access door 1904 that pivots on pivot joint 1908 with respect to the outer housing 1902 from an open configuration shown in FIG. 19a to a partially closed configuration shown in FIGS. 19b-c. In the partially closed configuration, the access door 1904 may prevent or minimise liquid from escaping the outer housing 1902 during operation of the foot and lower leg treater or washer.

The outer housing 1902 may be provided with one or more handles 1906 for a user to grasp, for example, to stabilise themselves when accessing the foot and lower leg treater or washer or during operation of the foot and lower leg treater or washer.

FIGS. 21a-21c show a third embodiment of a foot and lower leg treater or washer 2100. The foot and lower leg treater or washer 2100 includes a similar structure of the footrest 1800, base 218 of the inner housing 104 and cleaning or treating assemblies 116a-d as those described above for the first embodiment. The foot and lower leg treater or washer 2100 includes an outer housing 2102 and an access door assembly 2104 formed from a pair of outer and inner shells 2106a-b connected to one or more pivot joints 2108 for pivoting the shells 2106a-b with respect to the outer housing 2102 from an open configuration shown in FIG. 21a to a partially closed configuration shown in FIGS. 21b-c. In one embodiment, each shell panel 2106a-b may operate between the open configuration and the partially closed configuration independently of each other. For example, outer shell panel 2106a may be in the partially closed configuration, while stackable panel 2106b is in the open configuration. In the partially closed configuration, the access door assembly 2104 may prevent or minimise liquid from escaping the outer housing 2102 during operation of the foot and lower leg treater or washer 2100. The dual shell panel configuration allows for easy access when in the lowered position as well as additional splash or leakage protection when in the raised positions. The shell panels may be manually or remotely operable.

The outer housing 2102 may be provided with one or more handles 2110 for a user to grasp, for example, to stabilise themselves when accessing the foot and lower leg treater or washer or during operation of the foot and lower leg treater or washer.

FIGS. 22a-22d show a fourth embodiment of a foot and lower leg treater or washer 2200. The foot and lower leg treater or washer 2200 includes an outer housing 2202 and an access door assembly 2204 including a plurality of telescoping shell panels connected to a pair of opposed pivot joints 2208 for pivoting the shell panels with respect to the outer housing 2202 from an open configuration to a partially closed configuration shown in FIG. 22a. In the embodiment shown in FIG. 22a, the access door assembly 2204 includes two inner shell panels 2206a-b and an outer shell 2206c, however, any number of inner and/or outer shell panels may be used. In one embodiment, each shell panel 2206a-c may operate between the open configuration and the partially closed configuration independently of each other. For example, outer shell panel 2206c may be in the partially closed configuration, while telescoping panels 2206a-b are in the open configuration. In the partially closed configuration, the access door assembly 2204 may prevent or minimise liquid from escaping the outer housing 2202 during operation of the foot and lower leg treater or washer 2200. The multi-shell panel configuration allows for easy access when in the lowered position as well as additional splash or leakage protection when in the raised positions. The shell panels may be manually or remotely operable.

The outer housing 2202 may be provided with one or more handles 2210 for a user to grasp, for example, to stabilise themselves when accessing the foot and lower leg treater or washer or during operation of the foot and lower leg treater or washer.

The outer housing 2202 houses a base assembly 2218 including footrest and one or more cleaning or treating assemblies 116a-d. In one embodiment, the footrest 1800 may include a single portion as shown in FIGS. 18 and 22b for receiving both feet and lower legs of the user. In another embodiment, the footrest may include a first portion and a second portion for receiving respective feet and lower legs as described in further detail below with reference to FIG. 28.

The outer housing 2202 may include a tilting assembly having a curved guide and follower arrangement acting between the base assembly 2218 and the outer housing 2202 for allowing the base assembly to travel along a curved path relative to the outer housing. The base assembly 2218 may include one or more followers or projections for slidably or rotatably engaging a curved guide of the outer housing 2202. Alternatively the outer housing may include the followers and the base assembly the guides. In the embodiment shown in FIGS. 22b-d, the one or more projections or followers are wheels that rotatably engage a pair of curved rails 2222. In the embodiment shown in FIGS. 22b-d, the rails 2222 may be located on one or more supports 2226 projecting upwards from a lowermost portion of the inner surface 2224 of the outer housing 2202. In another embodiment, the rails 2222 may be integrally formed with the inner surface 2224 of the outer housing 2202. The outer housing 2202 and base assembly 2218 may be suitably shaped and dimensioned to permit translation and inclination or tilting of the base assembly within the outer housing, in this case using the curved rails and wheels.

In one embodiment, the base assembly 2218 may be manually inclined or tilted and translated with respect to the outer housing 2204 by the user moving the base assembly 2218 relative to the outer housing 2204 along the curved tracks or rails using their feet. Translation and inclination or tilting of the base assembly 2218 relative to the outer housing 2204 may provide a user with a more comfortable and natural inclined foot and leg position during use, especially if the user is in a seated position. In particular the curved path followed by the base assembly approximates the path of the feet of the user as the lower legs swing or pivot from the knees so that the user can move their feet or allow their feet to be moved into the most comfortable position.

In another embodiment the base assembly is moved with respect to the outer housing by an actuator or ram similar to that indicated in FIGS. 5a to 5c. Alternatively, at least one of the tracks may be in the form of a rack and the corresponding follower may be in the form of a pinion which is moved by a rotary actuator. The base assembly 2218 may include one or more rotatable upright cleaning or treating assemblies 116a-c and/or one or more rotatable transversely extending cleaning or treating assemblies 116d as described herein. The one or more rotatable upright cleaning or treating assemblies may be configured to move around a portion of the footrest 1800 during a lower leg and foot cleaning cycle. In one embodiment shown in FIGS. 23a-c, the base assembly 2318 includes two rotatable upright cleaning or treating assemblies 116a-116b that move around respective portions of 2802a,b of the footrest during a lower leg and foot cleaning cycle and a rotatable transversely extending cleaning or treating assembly 116d. The two rotatable upright cleaning or treating assemblies 116a-116b may be suitable for washing, treating or massaging an exterior portion of a user's lower leg, while the rotatable transversely extending cleaning or treating assembly 116d may be suitable for washing, treating or massaging the user's feet, depending on the type of detachable attachment used. In another embodiment, the base assembly 2218 includes a single rotatable upright cleaning or treating assembly for washing or treating one or both lower legs and feet of a user and a rotatable transversely extending cleaning or treating assembly for washing or treating a user's feet.

In one embodiment, the one or more rotatable upright cleaning or treating assemblies 116a-b and/or rotatable transversely extending cleaning or treating assembly 116d are connected to a base plate 2324 of the base assembly 2318 via holders 2330. As shown in FIG. 23a, each rotatable upright cleaning or treating assembly includes a brush or other cleaning or treating attachment 116a-b arranged on a rotatable upright shaft 1000a,b that is connected to a rotary arm 2332a,b by one or more support clamps 2302. Each rotary arm 2332a,b is driven around a track of guiding plate 2328 that surrounds portions of the footrest 2802a,b by a drive assembly (described in further detail below) housed in a hull 2320 of the base assembly 2318.

In the instance where two or more upright cleaning or treating assemblies are used, the drive assembly may operate these assemblies either concurrently or sequentially. In the embodiment shown in FIGS. 23b-c, the rotatable upright cleaning or treating assembly 116b is configured to wash and/or massage a user's lower left leg and foot by moving from a first position 2342 adjacent to a left side of footrest 2802b to a second position 2344 adjacent to a right side of footrest 2802b and return to the first position 2342. Sequentially or concurrently, the rotatable upright cleaning or treating assembly 116a is configured to wash and/or massage a user's lower right leg and foot by moving from a first position 2346 adjacent to a right side of footrest 2802a to a second position (not shown) adjacent to a left side of footrest 2802a and return to the first position 2346. In an embodiment where a single upright brush is used, the upright brush is configured to wash and/or massage a user's lower legs and feet by moving from a first position adjacent to the left or right side of a footrest 2802a,b to an intermediate position located between the user's lower legs and feet and to a second position located adjacent to the right or left side of the footrest 2802a,b, respectively, before returning to the first position via the intermediate position.

The operation of one or more upright cleaning or treating assemblies 116a-b may occur concurrently or sequentially with the operation of the one or more transversely extending cleaning or treating assemblies 116d. The operation of the one or more upright cleaning or treating assemblies 116a-b may alternatively occur without operation of the one or more transversely extending cleaning or treating assemblies 116d. In yet another mode, the one or more transversely extending cleaning or treating assemblies 116d operate without the concurrent operation of the upright cleaning or treating assemblies 116a-b.

One or more pipes 2340a,b may be connected to an opening in the hull 2320 of the base assembly 2318, which provides a waterproof plenum for accommodating motors or actuators for driving the cleaning or treating assemblies. In one embodiment, the one or more pipes 2340a,b may be made from flexible and/or extendible material to accommodate inclination of the base assembly 2318 within the outer housing 2202. In the embodiment shown in FIGS. 23a-c, pipes 2340a,b may be connected to a cooling system (not shown) where pipe 2340a is an inlet pipe for supplying air to the hull 2318 and pipe 2340b is an outlet pipe for removing air from hull 2318 to cool the drive assembly accommodated therein. In another embodiment, the one or more pipes 2340a,b may be a conduit for supplying electrical cables to the drive assembly located in the hull 2318.

In one embodiment shown in FIGS. 24a-d, the base assembly 2418 includes a similar structure of the base assembly 2318 described with reference to FIGS. 23a-c, except that it also includes one fixed intermediate rotatable upright cleaning or treating assembly 116c. The fixed intermediate rotatable upright cleaning or treating assembly 116c may be suitable for washing, treating or massaging an inner portion of a user's lower leg.

With reference to FIGS. 24a-b, the hull 2320 may house one or more motors or drive assemblies in a waterproof plenum for rotating and driving the rotatable upright cleaning or treating assemblies 116a-b around track of guiding plate 2328 that surrounds a portion of footrest/s 1800, 2800 and/or rotating the fixed intermediate rotatable upright cleaning or treating assembly 116c and/or rotating the one or more transversely extending cleaning or treating assemblies 116d. In one embodiment, the drive assembly 2401 includes a first and a second actuator or motor 2402a,b respectively coupled to a first and a second transmission mechanism 2404a,b. In the embodiment shown in FIGS. 24a-d, the first and second actuators 2402a,b are coupled to the respective first and second transmission mechanisms 2404a,b by respective first and second universal joints 2410a,b. Actuation of the first and second actuators 2402a,b drives the first and second universal joints 2410a,b to transmit rotatory motion to the transmission mechanisms 2404a,b for pivoting rotary arms (not shown) of the rotatable upright cleaning or treating assemblies 116a,b on bearings 2420a,b and driving rotary arm 2332a,b around a track of guiding plate (not shown) that surrounds a portion of the footrest 2800a,b.

Each transmission mechanism 2404a,b is coupled to a transmission mechanism 2406a,b of a guiding mechanism 2414. In the embodiment shown in FIG. 24d, each transmission mechanism 2404a,b is a worm wheel that is coupled to a worm gear 2406a,b located at respective ends of transmission shaft 2408 of guiding mechanism 2414. The guiding mechanism 2414 further includes an actuator 2416 that drives transmission mechanism 2412 that transmits rotary motion to a transmission mechanism 2413 of the transmission shaft 2408. Selective activation of actuator 2416 with any one of actuators 2402a or 2402b drives rotary arms (not shown) of the rotatable upright cleaning or treating assemblies 116a-b around a track of guiding plate 2328 in a first direction or a second direction opposite to the first direction. In one embodiment, the transmission mechanisms 2412, 2413 are respective first and second bevel gears for reversing the direction of rotation of the transmission shaft 2408 and/or changing the speed of rotation of the transmission shaft 2408. In another embodiment, the transmission mechanisms 2412, 2413 are respective first and second miter gears for reversing the direction of rotation of the transmission shaft 2408.

The drive assembly associated with the intermediate rotatable upright cleaning or treating assembly 116c includes an actuator 2402c coupled to a transmission mechanism 2404c. In the embodiment shown in FIGS. 24c-d, the actuator 2402c is coupled to the transmission mechanism 2404c by a universal joint 2410c. Actuation of actuator 2402c drives the universal joint 2410c to transmit rotatory motion to the transmission mechanism 2404c for pivoting the upright shaft 1000c of the intermediate rotatable upright cleaning or treating assembly 116c on bearing 2420c. In the embodiment shown in FIGS. 24a-d, the actuators 2404a-c are brushless motors.

FIGS. 25a-c illustrate one example of a rotatable upright cleaning or treating assembly 116a arranged on a rotatable upright shaft 1000a that is connected to rotary arm 2332a by one or more support clamps 2302. The rotary arm 2332a is connected to the base plate (not shown) of base assembly (not shown) by holder 2330. Rotary arm 2332a is driven by drive assembly including actuator 2402a that drives the universal joint 2410a to transmit rotatory motion to the transmission mechanism 2406a for pivoting rotary arm 2322a of the rotatable upright cleaning or treating assemblies 116a on bearing 2420a.

Rotation of the rotatable upright cleaning or treating assemblies 116a-c may be driven by the drive assembly whereby actuation of actuator 2402a drives the universal joint 2410a to transmit rotary motion to a series of drive shafts 2502, 2504 coupled to universal joints 2410d, 2410e.

In one embodiment, the rotatable upright cleaning or treating assemblies 116a-116b that move around a portion of the footrest are dynamically adjustable by a biasing means for biasing the one or more upright cleaning or treating assemblies against one or more lower legs of a user thereby to accommodate different lower leg profiles. In the embodiment shown in FIGS. 25a-c, the biasing means includes one or more hydraulic or pneumatic cylinders 2512a,b and corresponding pistons 2514a,b located on and forming part of the rotary arm 2332a, allowing the rotary arm to extend and retract, with the drive shaft 2504 being extendible and retractable for permitting extension and retraction of rotary arm 2332a. The cylinder and piston may be in the form of a gas strut, which may be adjustable. In another embodiment, the biasing means may be a spring and piston arrangement located on the rotary arm 2332a as described with reference to FIG. 10.

In one embodiment, each rotatable upright cleaning or treating assembly 116a-116b that move around a portion of the footrest are connected at its uppermost portion to an adjustable adaptor as described with reference to FIG. 12 that engages a rail provided on the inner surface 2224 of the outer housing 2202.

With reference to the embodiment shown in FIG. 26, the rotary arm 2332a and drive assembly includes a similar structure as described with reference to FIGS. 25a-c, except that each universal joint of the drive assembly 2410a,d,e has been replaced with a gear arrangement including a first gear and a second gear for achieving 90 degree rotation. The first and second gears may be any one of: a worm gear 2602, worm wheel 2604, bevel gear 2608, 2610, 2612, 2614 or mitre gear.

FIGS. 27a-b show another embodiment of a drive assembly 2701 for rotating and alternating the driving of each rotatable upright cleaning or treating assembly (not shown) around track of guiding plate (not shown) that surrounds a portion of footrest 2800a,b. In the embodiment shown in FIGS. 27a-b, the drive assembly 2701 includes a first and a second actuator 2702a,b that drives respective first and second transmission mechanisms 2704a,b to transmit rotary motion to respective transmission mechanisms 2708a,b of each rotary arm 2332a,b for pivoting rotary arms 2332a,b of the rotatable upright cleaning or treating assemblies on bearings 2720a,b and driving each rotary arm 2332a,b around a track of guiding plate (not shown) that surrounds a portion of the footrest 2800a,b. Any one of the first and second transmission mechanisms 2704a, 2404b 2708a, 2708b may be a worm wheel or worm gear.

Each rotary arm 2332a,b includes a transmission mechanism 2712a,b coupled to guiding mechanism 2714. The guiding mechanism 2714 includes a first actuator 2716a and a second actuator 2716b connected to respective transmission mechanisms 2713a,b for coupling to the respective transmission mechanisms 2712a,b of each rotary arm 2332a,b. Each of actuators 2716a,b are coupled to supporting plates 2718a,b. Selective activation of actuators 2702a, 2716a will rotate rotatable upright cleaning or treating assembly 116a and drive rotary arm 2332a around the track of guiding plate (not shown) in a first direction, while rotating rotatable upright cleaning or treating assembly 116b and driving rotary arm 2332b around the track of guiding plate in a second direction opposite the first direction. Conversely, selective activation of actuators 2702b, 2716b will rotate rotatable upright cleaning or treating assembly 116b and drive rotary arm 2332b around the track of guiding plate (not shown) in a first direction, while rotating rotatable upright cleaning or treating assembly 116a and driving rotary arm 2332a around track of guiding plate in a second direction opposite the first direction. Any one of transmission mechanisms 2712a, 2712b, 2713a or 2713b may be a bevel gear or a mitre gear.

In another embodiment, the drive assembly may be a hydraulic or pneumatic drive assembly connected to an actuator. The actuator may located in the hull of the base assembly or may be located external to the outer housing of the foot and lower leg treater or washer. In one embodiment, the outer housing of the foot and lower leg treater or washer may be connected to an external compressor for providing pressurized fluid and/or air to the hydraulic or pneumatic drive assembly to assist in rotating and driving each rotatable upright cleaning or treating assembly around track of guiding plate that surrounds a portion of the footrest. A single external compressor may service a bank of devices which are collocated.

The one or more transversely extending cleaning or treating assemblies 116d may have a structure similar to that described herein, except that each transversely extending cleaning or treating assembly (not shown) may be adjusted in height by the one or more slip joints 2722 located in openings 2724 in housing 2706. In one embodiment, the user may apply pressure on the brush attachments with their feet to extend or collapse slip joints 2722 in openings 2724 in order to adjust the height of the transversely extending cleaning or treating assembly.

FIG. 28 shows an embodiment of a footrest 2800 located within the outer housing 2202 of the foot and lower leg treater or washer 2200. In one embodiment, the footrest 2800 includes a first portion 2802a and a second portion 2802b having one or more supporting plates 2804a,b for receiving portions of the respective feet of a user. In another embodiment, the footrest 2800 includes a first portion that is capable of receiving both feet of the user. The footrest 2800 may also aid in maintaining and supporting the user's feet and lower legs in a predetermined position during washing and/or treatment. In one embodiment, each of the first portion 2802a and the second portion 2802b are coupled to an uppermost surface of respective rotary arms 2332a,b as shown in FIG. 23a. In one embodiment, the footrest 2800 may be coated in a non-slip coating to prevent slippage and aid in the stability of the user during washing of their feet and lower legs. In another embodiment, the footrest may be provided with a support plate having an array of micro actuators as described with reference to FIG. 18.

In one embodiment, each portion 2802a,b of the footrest 2800 is capable of being adjusted from a collapsed configuration as shown by example in FIG. 28a to an expanded configuration as shown by example in FIG. 28b. It will be appreciated that in other embodiments, each portion 2802a,b of the footrest 2800 may be adjusted to an intervening configuration.

In the embodiment shown in FIGS. 28a-b, supporting plates 2804a,b may be coupled to one or more slip joints 2806 which are sprung biased into a closed position for adjusting each of the first and second portions 2800a,b of footrest 2800 to accommodate differences in the lengths and/or widths of various user's feet and/or each respective foot of a user.

The one or more supporting plates of footrest 2800 may be provided with one or more flanges for assisting in guiding a user's feet into position and/or aid in maintaining and supporting the user's feet and lower legs in a predetermined position during washing and/or treatment. In the embodiment shown in FIGS. 28a,b, one or more flanges 2810a,b project upwardly from a portion of each exterior facing surface 2812a,b of the supporting plates 2804a,b.

FIGS. 29a-c show a fifth embodiment of a foot and lower leg treater or washer 2900. The foot and lower leg treater or washer 2900 includes an outer housing 2902 and a chair assembly 2904. In one embodiment, the chair assembly 2904 is capable of being adjusted with respect to the outer housing 2902 for assisting user entry to, and exit from, the washer and/or facilitating an operating position that is comfortable for the user during washing and/or treatment. The chair assembly 2904 is adjustable from a stowed configuration shown by example in FIG. 29a to an expanded configuration shown by example in FIG. 29c by sliding on one or more rails 2906 that connect the chair assembly 2904 to the outer housing 2902. In one embodiment, the chair assembly 2904 slides with respect to the outer housing 2902 by the user manually sliding the chair assembly 2904 along the rails 2906 relative to the outer housing 2902. In another embodiment, the one or more rails 2906 are connected to an actuator 2908 for moving the chair assembly 2904 relative to the outer housing 2902.

The outer housing 2902 includes an access door assembly 2910 including a panel 2912 pivotally connected to outer housing 2902. In one embodiment, the panel 2912 may be connected to actuator 2908 for moving the panel 2912 from a closed position to an open position. In another embodiment, the panel 2912 may be manually opened and closed by a user. The outer housing 2902 may be provided with a control panel display and access door assembly and house any of the previously described base assemblies, controller, fluid supply mechanism 2002 and components thereof. In the embodiment shown in FIG. 29c, outer housing 2902 includes the base assembly 2318 shown in FIGS. 23a-c, the drive assembly 2701 shown in FIGS. 27a-b and the fluid supply mechanism 2002 and pump 2000 of FIG. 20.The chair assembly 2904 includes a chair 2914 pivotably connected to a base 2916 for permitting the chair 2914 to pivot between a stowed configuration shown by example in FIG. 29a to a rotated configuration shown in FIG. 29b. The chair assembly 2904 may further include any one or more of: a speaker/s 2918, head rest 2920, back rest 2922, arm rest/s 2924, seat 2926, or the control panel display 700. The chair assembly may be fully adjustable to facilitate access to the outer housing 2902. In one embodiment, the chair 2914 is adjustable in height and/or angle relative to the base 2916 in accordance with the measurements of the user, and in particular the length of the user's lower legs so that their feet can rest comfortably on the footrests.

The embodiments described in any one or more of FIGS. 22a-d, FIGS. 23a-c, FIGS. 24a-d, FIGS. 25a-c, FIG. 26, FIGS. 27a-b, FIGS. 28a-b or FIGS. 29a-c may interchangeably be provided with any one or more of: a control panel display; a controller; a rotatable transverse cleaning and fan sub-assembly; rotary coil attachments; rotary brush attachments; rotary sponge attachments; liquid jet attachments; air dryer attachments; massage attachments; access door assembly or fluid supply mechanism as described herein.

It will be understood that the invention disclosed and defined in this specification extends to all alternative combinations of two or more of the individual features mentioned or evident from the text or drawings. All of these different combinations constitute various alternative aspects of the invention.

1. A device for washing or treating the feet and lower legs of a user, said device comprising:
an outer housing;
a base assembly located in the outer housing;
access structure providing access of the feet and lower legs to the base assembly;
a controller controlling operation of the device; and
a fluid supply mechanism;
the base assembly including:
at least one footrest supporting the feet and lower legs of a user during washing or treating;
one or more rotatable transversely extending cleaning or treating assemblies located above the footrest and washing or treating a user's feet; and
one or more rotatable upright cleaning or treating assemblies washing or treating one or both lower legs of the user; and
a tilting assembly tilting the base assembly relative to the outer housing through a plurality of inclined positions.

2. The device of claim 1, wherein the base assembly includes a hull housing one or more drive assemblies in a waterproof plenum, said drive assemblies driving the one or more rotatable transversely extending cleaning or treating assemblies and the one or more rotatable upright cleaning or treating assemblies.

3. The device of claim 1, wherein the tilting assembly includes a curved guide and follower arrangement acting between the base assembly and the outer housing so as to allow the base assembly to travel along a curved path relative to the outer housing.

4. The device of claim 1, wherein the base assembly includes an inner housing and the tilting assembly includes one or more lifting and lowering mechanisms connecting the base assembly to the inner surface of the outer housing so as to provide tilting of the inner housing with respect to the outer housing.

5. The device of claim 1, wherein the one or more rotatable upright cleaning or treating assemblies are carried on a guiding mechanism moving each of the one or more cleaning or treating assemblies around an outer portion of the footrest during a lower leg and foot cleaning or treating cycle in which outwardly facing portions of the lower legs are cleaned or treated, each guiding mechanism being dynamically adjustable so as to accommodate different lower leg profiles.

6. The device of claim 5, wherein each guiding mechanism includes a rotary arm the length of the rotary arm being dynamically adjustable and including biasing structure biasing the one or more upright cleaning or treating assemblies against the one or more lower legs of the user so as to accommodate the different lower leg profiles.

7. The device of claim 6, wherein the biasing structure includes a hydraulic or pneumatic strut.

8. The device of claim 1, wherein the one or more rotatable upright cleaning or treating assemblies includes a fixed intermediate rotatable cleaning or treating assembly that is positioned between the footrests and is configured to clean or treat inwardly facing or medial portions of the lower legs of the user.

9. The device of claim 5, wherein the one or more rotatable upright cleaning or treating assemblies include a pair of cleaning or treating assemblies carried on a corresponding pair of guiding mechanisms moving each of the cleaning or treating assemblies around both an outer portion of the footrest and an inner portion of the footrest during a lower leg and foot cleaning or treating cycle in which outwardly and inwardly facing or medial portions of the lower legs are cleaned or treated, each guiding mechanism being dynamically adjustable so as to accommodate different lower leg profiles.

10. The device of claim 9, wherein the inwardly facing or medial portions of each of the lower legs are simultaneously or alternately cleaned or treated by the guiding mechanisms.

11. The device of claim 1, wherein the access structure includes an access door assembly having a plurality of telescoping panels movable between open and closed positions.

12. The device of claim 1, wherein the outer housing includes a control display interfacing with the controller and displaying one or more indicators and/or controls of: water temperature, water intensity, water pressure, air drying intensity, inclination of the foot washer, or operation of the access structure.

13. The device of claim 1, wherein the rotatable transversely extending or rotatable upright cleaning or treating assemblies include one or more of interchangeable attachment, said attachments each being selected from the group consisting of a coil attachment; a brush attachment; a sponge attachment; a liquid jet attachment; an air dryer attachment; and a massage attachment.

14. The device of claim 13, wherein the attachment is a coil attachment that includes a cylindrical housing having a series of hollow concentric tubes separated by grooves having one or more balls provided on an interior surface therein.

15. The device of claim 14, wherein the coil attachment is inflatable by an air supply mechanism.

16. The device of claim 14, wherein the coil attachment is connected to an inclination mechanism inclining the coil attachment relative to the base assembly.

17. The device of claim 1, wherein the at least one footrest includes an array of micro actuators detecting size and/or dimensions of feet of the user on the footrest and providing varying pressure intensities to the feet of the user.

18. The device of claim 1, wherein the at least one footrest includes one or more adjustable supporting plates coupled to one or more biasing structures adjusting each footrest so as to accommodate a length and/or width of a user's foot.

19. The device of claim 1, wherein the device is integrated with a chair assembly.

20. The device of claim 19, wherein the chair assembly includes a chair pivotally and slidably connected to a base so as to permit the chair to pivot between a stowed configuration and a rotated configuration and to slide to and fro relative to the device.

21. A device for washing or treating the feet and lower legs of a user, said device comprising:
an outer housing partially surrounding an inner housing, wherein the inner housing defines a tub and is movable with respect to the outer housing between a plurality of inclined positions and a stowed position;
control structure controlling operation of the device;
the tub including:
at least one footrest supporting the feet and lower legs of a user during washing or treating in an inclined position;
access structure providing the feet and lower legs of the user with access to the footrest;
a fluid supply mechanism introducing fluid into the tub;
one or more rotatable transversely extending cleaning or treating assemblies located above the footrest and washing or treating the feet of the user; and
one or more rotatable upright cleaning or treating assemblies washing or treating one or both of the lower legs of the user.
